(19) United States
(12) Patent Application Publication
(10) Pub. No.: US 2010/0312713 A1
(43) Pub. Date: Dec. 9, 2010

(54) METHODS AND SYSTEMS FOR IDENTIFYING CAREER-RELATED EVENTS AND PROSPECTIVE CAREER-RELATED NETWORKING CONTACTS VIA AN INTERNET-BASED PLATFORM

(76) Inventor: Brent Rickey Keltner, South Hamilton, MA (US)

Correspondence Address: CHOATE, HALL & STEWART LLP, TWO INTERNATIONAL PLACE, BOSTON, MA, 02110, US

(21) Appl. No.: 12/797,417

(22) Filed: Jun. 9, 2010

Related U.S. Application Data
(60) Provisional application No. 61/185,435, filed on Jun. 9, 2009.

(51) Int. Cl. G06Q 99/00; G06F 3/00

(52) U.S. Cl. 705/317; 705/319; 715/745

(57) ABSTRACT

The present disclosure is directed to methods and systems for identifying career-related events and prospective career-related networking contacts for a user of a career development networking service. A server can receive profile information of a user, match the user with a group of users of a career development networking service based on the profile information of the user and profile information of the group of users, identify a career-related event attended by a threshold number of users matched to the user, and display the career-related event to the user. The server can also receive a selection of a career-related event from a user, receive a request for an enumeration of attendees of the career-related event according to a criterion, identify attendees of the career-related event that meet the criterion, and display the identified attendees to the user.

### RELATED APPLICATIONS

The present application claims priority to U.S. application Ser. No. 61/185,435, entitled “Methods and Systems for Identifying a Peer Career Development Match” and filed on Jun. 9, 2009, which is herein incorporated by reference in its entirety.

### FIELD OF THE INVENTION

The present disclosure is directed to methods and systems for identifying career-related events and prospective career-related networking contacts via an Internet-based platform.

### BACKGROUND OF THE INVENTION

Conventional networking can be a haphazard, low-yield process. Working professionals may seek referrals to meet their career needs, but the success of referrals can depend on the depth of their contacts' networks and how efficiently information flows through those networks. Further, these professionals can attend career-related events, such as industry events, conferences, trade expos, and alumni or professional association meetings, and meet few people with the skills and connections to develop their careers. In this manner, professionals have limited control over the quality and appropriateness of career-related networking contacts they acquire, and meeting needed career-related networking contacts can greatly depend on luck and chance.

### BRIEF SUMMARY OF THE INVENTION

The present disclosure is directed to an Internet-based platform that enables professionals to acquire career-related networking contacts efficiently, effectively, and pro-actively. Based on the profile information of a user, a career development networking service on the platform can identify prospective career-related networking contacts that would meet the user's networking needs. The service can identify events that these career-related networking contacts will attend, inform the user of the events, and enable the user to identify connections the user should seek to form at the events. Further, the service can enable users to evaluate and store contacts from these events for future reference.

In one aspect, the present disclosure is directed to a method for identifying a career-related event for a user of a career development networking service. The method includes receiving profile information of a user. The method also includes matching the user with a group of users of a career development networking service based on the profile information of the user and profile information of the group of users. The method also includes identifying a career-related event attended by a threshold number of users matched to the user. The method also includes displaying the career-related event to the user.

In various embodiments, the method also includes enhancing the profile information of the user. Enhancing the profile information can include identifying skills, educational credentials, or transition opportunities for acquisition based on the profile information of the user; analyzing profile information of users of the professional networking service with whom the user forms connections; analyzing skills, roles, or educational credentials of the users of the professional networking service with whom the user forms connections; or retrieving information about activities of the user from a third-party server.

Matching the user can include matching the user with a group of users based on the enhanced profile information of the user and profile information of the group of users. Receiving the profile information of a user can include receiving prioritized objectives of the user. Matching the user can include weighting users with profile information that matches the prioritized objectives of the user. Displaying the career-related event can include sending an invitation to the career-related event to the user.

In another aspect, the present disclosure is directed to identifying prospective career-related networking contacts attending a career-related event for a user of a career development networking service. The method includes receiving a selection of a career-related event from a user. The method also includes receiving a request for an enumeration of attendees of the career-related event according to a criterion. The method also includes identifying attendees of the career-related event that meet the criterion. The method also includes displaying the identified attendees to the user.

Receiving a request for an enumeration of attendees can include receiving a request for an enumeration of attendees of the career-related event that meet networking criteria based on the profile information of the user; receiving a request for an enumeration of attendees of the career-related event that meet a criterion selected by the user; or receiving a request for an enumeration of attendees of the career-related event that meet a career family, career path, role, goal, or company selected by the user. Displaying the identified attendees can include highlighting the identified attendees. The method can also include displaying attendees that do not meet the criterion after the attendees that meet the criterion.

In another aspect, the present disclosure is directed to an apparatus for identifying a career-related event and prospective networking targets for a user of a career development networking service. The apparatus includes a receiver for receiving profile information of a user of a career development networking service. The apparatus also includes a profile generation and enhancement engine for generating and enhancing profile information of the user. The apparatus also includes a matching and recommendation engine for i) matching the user with a group of users of the career development networking service based on the profile information of the user and profile information of the group of users, ii) identifying a career-related event attended by a threshold number of users from the group of users, iii) receiving a request for an enumeration of attendees of the career-related event according to a criterion; and iv) identifying attendees of the career-related event that meet the criterion. The apparatus also includes a user interface generation engine for generating a user interface to display i) the career-related event, or ii) the identified attendees.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising local machines in communication with remote machines;

FIG. 1B is a block diagram depicting one embodiment of a computing device useful in connection with the methods and systems described herein;

FIG. 2 is a block diagram depicting an embodiment of a system hosting a career development networking service;

FIGS. 3A-3D are exemplary screenshots of user interfaces for receiving profile information from a user;

FIGS. 4A and 4B are exemplary screenshots of user interfaces for viewing profiles;

FIG. 5A-5D are exemplary screenshots of user interfaces for requesting a search for a recommendation;

FIGS. 6A and 6B are exemplary screenshots of user interfaces for communication sessions;

FIGS. 7 and 8 are exemplary flow diagrams of methods for peer-based career development via an Internet platform;

FIG. 9 is an exemplary screenshot of a display of career-related events with attendees that can meet a user's networking objectives;

FIGS. 10A-10D are exemplary screenshots of displays through which a user can request an enumeration of attendees according to a criterion;

FIG. 11 is an exemplary screenshot of a display of attendees at a career-related event who meet networking criteria based on the profile information of the user;

FIGS. 12A and 12B are exemplary screenshots of profiles of users of the career development networking service;

FIGS. 13A-13C are exemplary screenshots of user interfaces for creating connections on the career development networking service; and

FIG. 14 is an exemplary screenshot of a display of a user's connections.

### DETAILED DESCRIPTION OF THE INVENTION

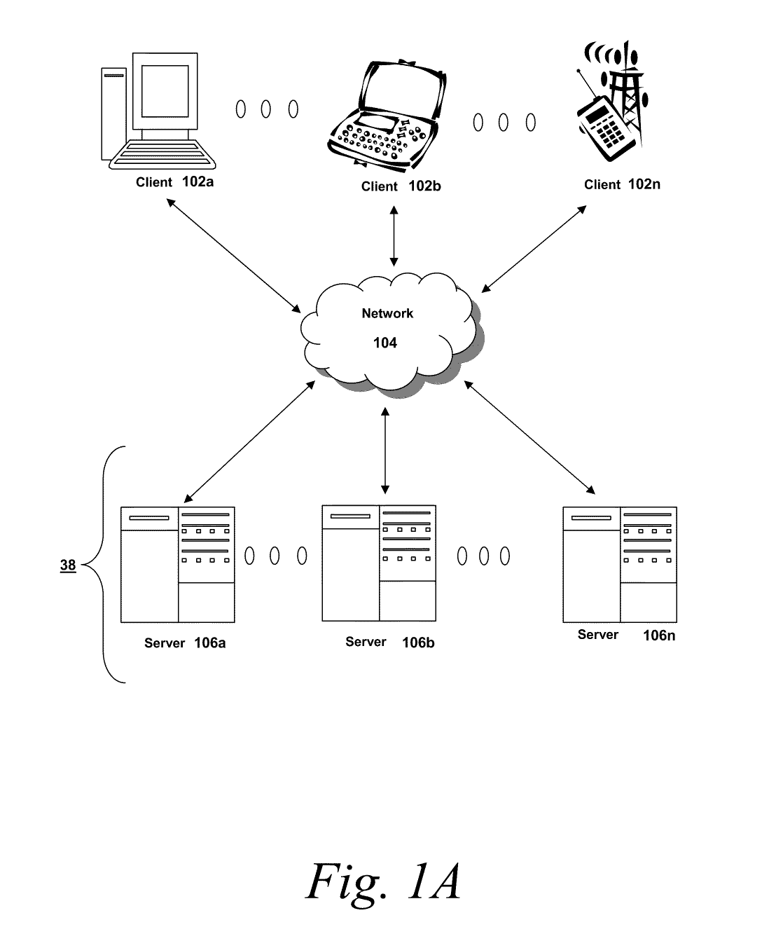

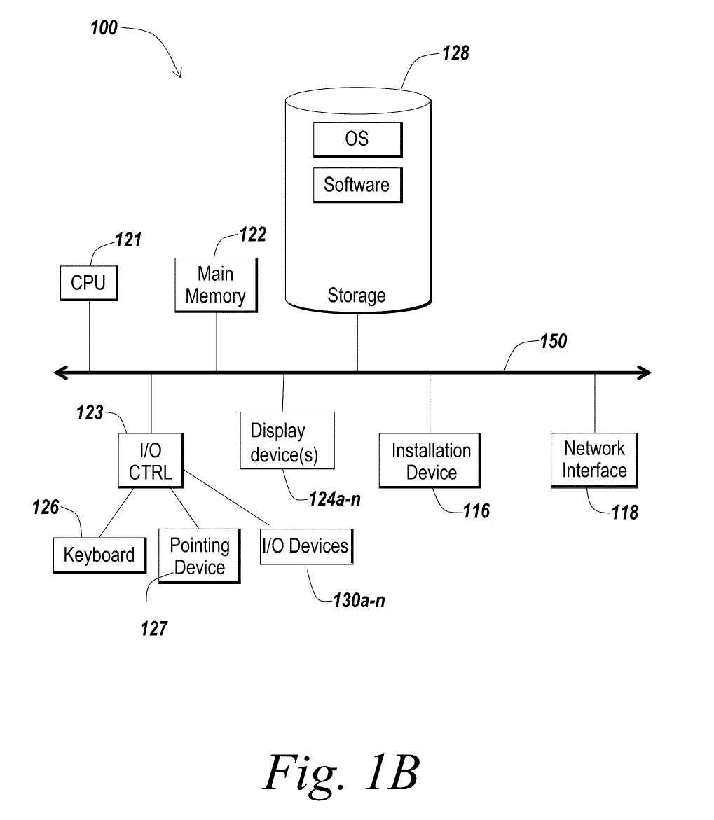

Referring now to FIG. 1A, an embodiment of a network environment is depicted. In brief overview, the network environment comprises one or more clients 102a-102n (also generally referred to as local machine(s) 102, or client(s) 102) in communication with one or more servers 106a-106n (also generally referred to as server(s) 106, or remote machine(s) 106) via one or more networks 104.

The servers 106 may be geographically dispersed from each other or from the clients 102 and communicate over a network 104. The network 104 can be a local-area network (LAN), such as a company Intranet, a metropolitan area network (MAN), or a wide area network (WAN), such as the Internet or the World Wide Web. The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

A server 106 may be referred to as a file server, application server, web server, proxy server, or gateway server. In one embodiment, the server 106 provides functionality of a web server. In some embodiments, the web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the SUN JAVA web server products provided by Sun Microsystems, of Santa Clara, Calif., or the BEA WEBLOGIC products provided by BEA Systems, of Santa Clara, Calif.

The clients 102 may be referred to as client nodes, client machines, endpoint nodes, or endpoints. In some embodiments, a client 102 has the capacity to function as both a client node seeking access to resources provided by a server and as a server providing access to hosted resources for other clients 102a-102n. A client 102 may execute, operate or otherwise provide an application, which can be any type and/or form of software, program, or executable instructions such as any type and/or form of web browser, web-based client, client-server application, an ActiveX control, or a Java applet, or any other type and/or form of executable instructions capable of executing on client 102. The application can use any type of protocol and it can be, for example, an HTTP client, an FTP client, an Oscar client, or a Telnet client.

The client 102 and server 106 may be deployed as and/or executed on any type and form of computing device, such as a computer, network device or appliance capable of communicating on any type and form of network and performing the operations described herein. FIG. 1B depicts a block diagram of a computing device 100 useful for practicing an embodiment of the client 102 or a server 106. As shown in FIG. 1B, each computing device 100 includes a central processing unit 121, and a main memory unit 122. As shown in FIG. 1B, a computing device 100 may include a visual display device 124, a keyboard 126 and/or a pointing device 127, such as a mouse.

The central processing unit 121 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, a computer 100 connects to a second computer 100′ on a network using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

In some embodiments, the computer 100 communicates with the computer 100′ when providing a user with a service made available by the Global System for Mobile Communications (GSM) standard. In other embodiments, the computer 100 provides a user with a short message service (SMS). In one of these embodiments, the computer 100 may transmit messages to the second computer 100′ via an intermediate computer 100″, such as a short message service center. In another of these embodiments, the computer 100 may transmit messages to the second computer 100′ according to a telecommunications protocol standard for transmitting digital data on a broadband network, such as the Signaling System 7 (SS7) protocol. In still other embodiments, the computer 100 transmits enhanced short messages to the computer 100′.

In other embodiments, the computer 100 transmits text messages to the computer 100′. In one of these embodiments, the text messages comply with the GSM standard for short messages. In another of these embodiments, the computers 100, 100′, 100″ transmit text messages that do not comply with a GSM standard. In still another of these embodiments, the computer 100 transmits text messages over a control channel between the computer 100 and a cell phone tower, which forwards the text messages to the recipient computer 100′.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIG. 1B typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MAC OS, manufactured by Apple Inc., of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others. A server 106 and a client 102 may be heterogeneous, executing different operating systems.

The computing device 100 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. For example, the computing device 100 may comprise a device of the IPOD family of devices manufactured by Apple Inc., of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In various embodiments, the computing device 100 can be a tablet computer, such as the iPad, manufactured by Apple Inc., of Cupertino, Calif. or the HP Slate, manufactured by Hewlett-Packard Company of Palo Alto, Calif.

In some embodiments, the computing device 100 may have different processors, operating systems, and input devices consistent with the device. For example, in one embodiment the computing device 100 is a TREO 180, 270, 600, 650, 680, 700p, 700w/wx, 750, 755p, 800w, Centro, or Pro smart phone manufactured by Palm, Inc. In some of these embodiments, the TREO smart phone is operated under the control of the PalmOS operating system and includes a stylus input device as well as a five-way navigator device. In various embodiments, the computing device 100 is a smartphone or any other device executing on the Android operating system developed by Google Inc., of Mountain View, Calif.

In other embodiments the computing device 100 is a mobile device, such as a JAVA-enabled cellular telephone or personal digital assistant (PDA), such as the i55sr, i58sr, i85s, i88s, i90c, i95c1, i335, i365, i570, 1576, i580, i615, i760, i836, i850, i870, i880, i920, i930, ic502, ic602, ic902, i776 or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, the Blackberry PEARL 8100, the 8700 series, the 8800 series, the Blackberry Storm, Blackberry Bold, Blackberry Curve 8900, and the Blackberry Pearl Flip. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc., of Cupertino, Calif. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill.. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a Motorola RAZR or Motorola ROKR line of combination digital audio players and mobile phones. In another of these embodiments, the computing device 100 is an iPhone smartphone, manufactured by Apple Inc., of Cupertino, Calif.

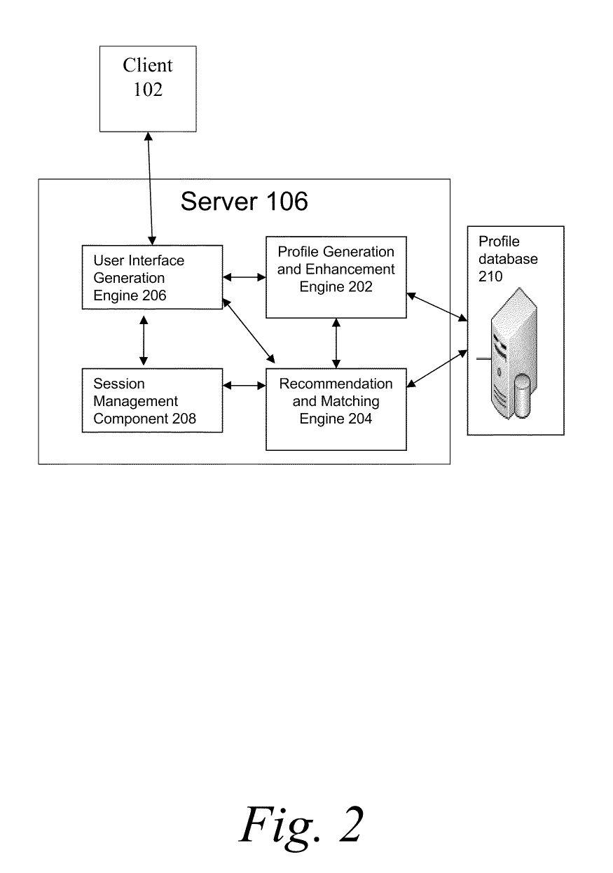

Referring now to FIG. 2, an exemplary block diagram of a system for peer-based career development via an Internet platform is shown and described. The system includes a profile generation and enhancement engine 202, a recommendation and matching engine 204, a user interface generation engine 206, a session management component 208, and a profile database 210.

The profile generation and enhancement engine 202 receives an identification of a user of a first type through at least one of: a career skill, a career transition, a career path, a career-related personnel characteristic, and positional career information. The profile generation and enhancement engine 202 generates a profile associated with the at least one user and storing the received identifications. In one embodiment, the profile generation and enhancement engine 202 is a component receiving data from users including, without limitation, identifications of career skills, career transitions, career paths, career-related personal information, and positional career information and generating at least one of a public profile and a private profile. In another embodiment, the profile generation and enhancement engine 202 receives information from consulting professionals who are displaying information to support the career development and career progression of other professionals. In still another embodiment, the profile generation and enhancement engine 202 receives information from inquiring professionals who are in search of career development help, including, but not limited to, help with developing a new career skill, planning career paths, managing a career transition, identifying a new job position, or managing organizational dynamics and challenges. In yet another embodiment, the profile generation and enhancement engine 202 receives information from aspiring professionals who are exploring career options during an initial stage of their career or prior to finishing their formal education. In some embodiments, the profile generation and enhancement engine 202 is in communication with a user interface generation engine 206, which generates user interfaces that receive data from users and forwards the data to the profile generation and enhancement engine 202.

The recommendation and matching engine 204 i) receives a request from a user of a second type for identification of at least one user with which to establish a communications session, the request including a search parameter identifying at least one of: a career skill, a career transition, a career path, a career-related personnel characteristic, a positional career information, networking goal, and employer characteristics, ii) analyzes at least one generated profile, and iii) transmits, to the user of the second type, an identification of the user of the first type, responsive to the analysis of the at least one generated profile. In one embodiment, the recommendation and matching engine 204 analyzes user profiles to establish matches between professionals based upon search criterion including, without limitation career skills, career transitions, career paths, career-related personal information, and positional career information. In one embodiment, the recommendation and matching engine 204 analyzes and matches profiles in response to direct user requests. In another embodiment, the recommendation and matching engine 204 analyzes and matches profiles without a direct user request by comparing match criterion for profiles in the profile database to establish indirect matches. In still another embodiment, the recommendation and matching engine 204 establishes indirect matches with a second user of a second type in response to a user search of position profiles. In yet another embodiment, the recommendation and matching engine 204 receives, from users, search criterion entered into the recommendation and matching engine 204; for example, search criterion may include different levels of prioritization to establish partial, exact, weighted, or paired matches. In some embodiments, the recommendation and matching engine 204 establishes matches to a plurality or group of users of the second type. In other embodiments, the recommendation and matching engine 204 is in communication with the user interface generation engine 206 and receives requests via a user interface.

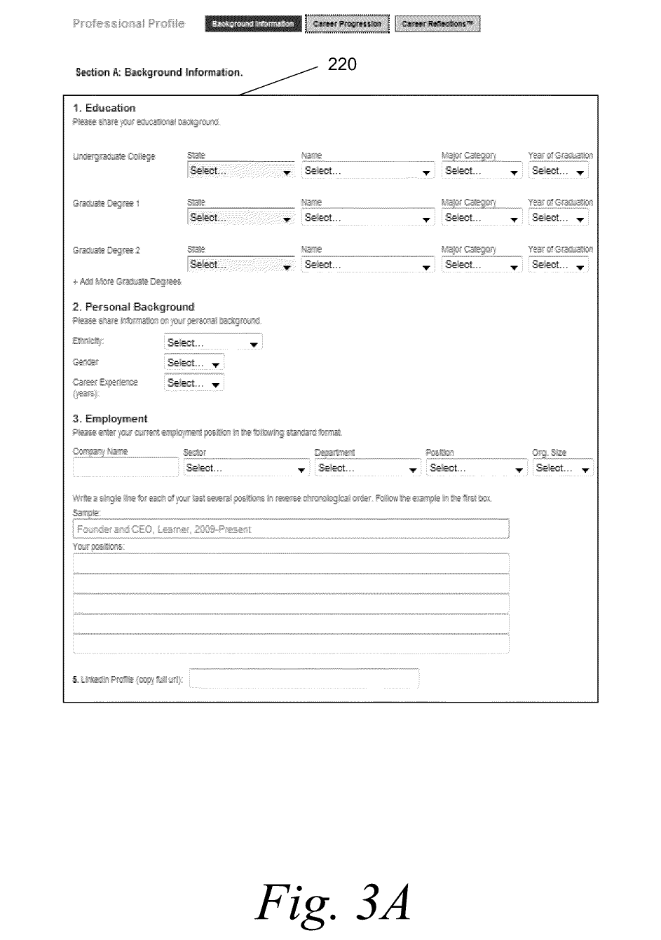

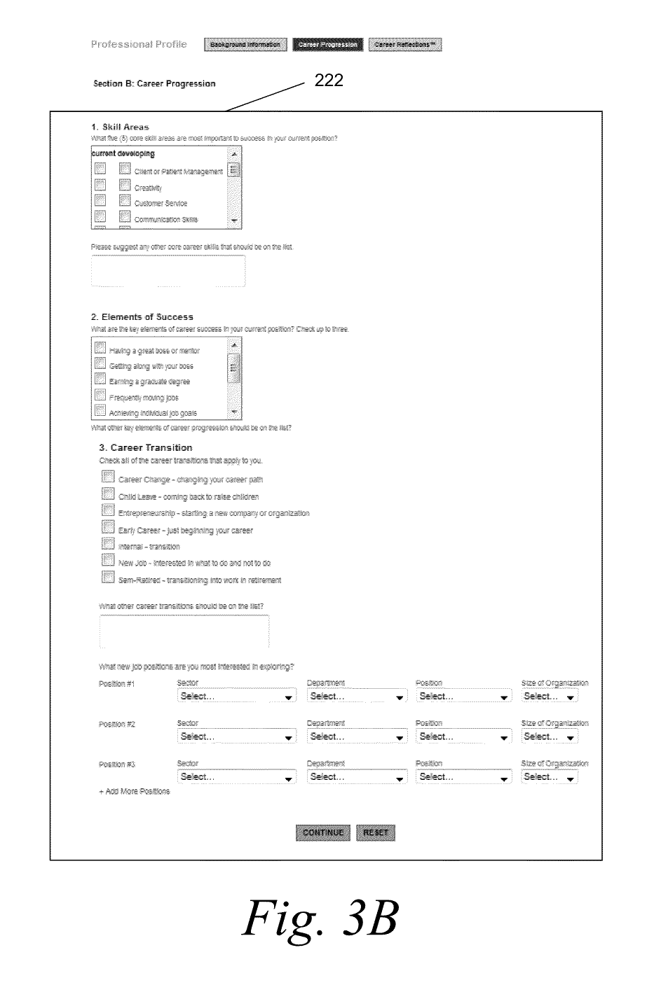

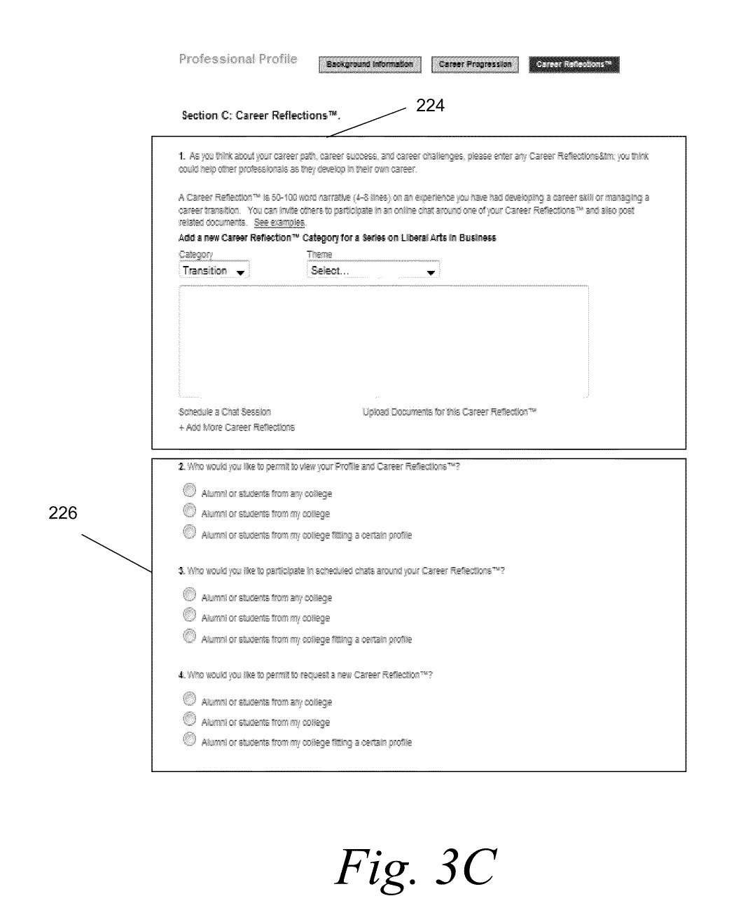

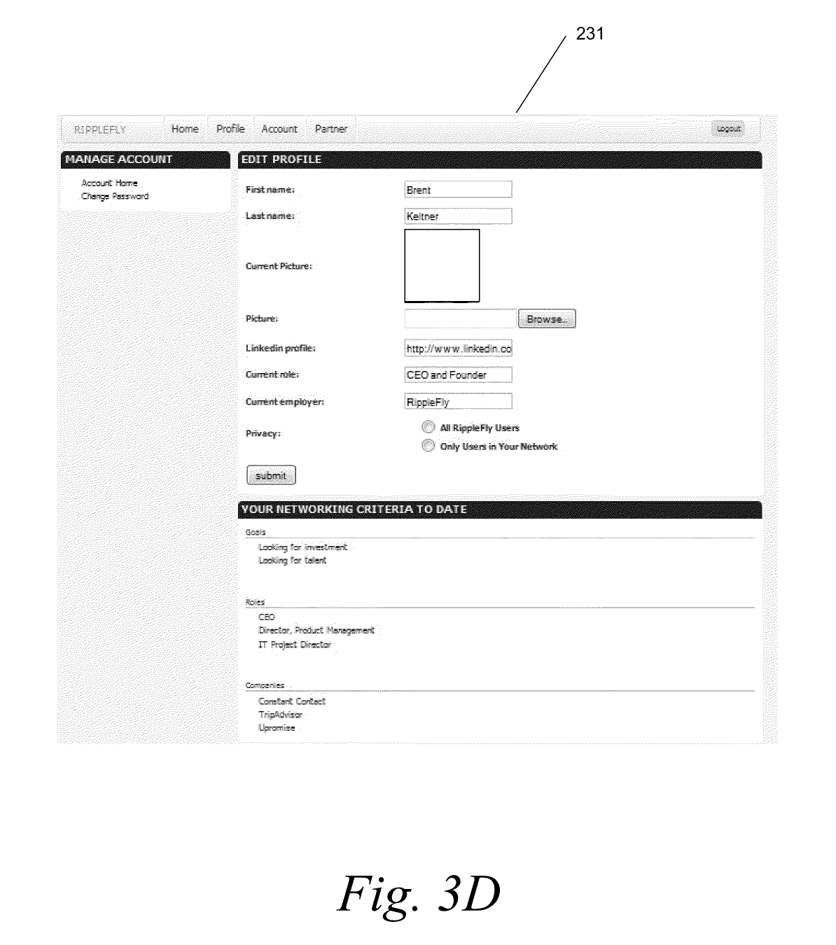

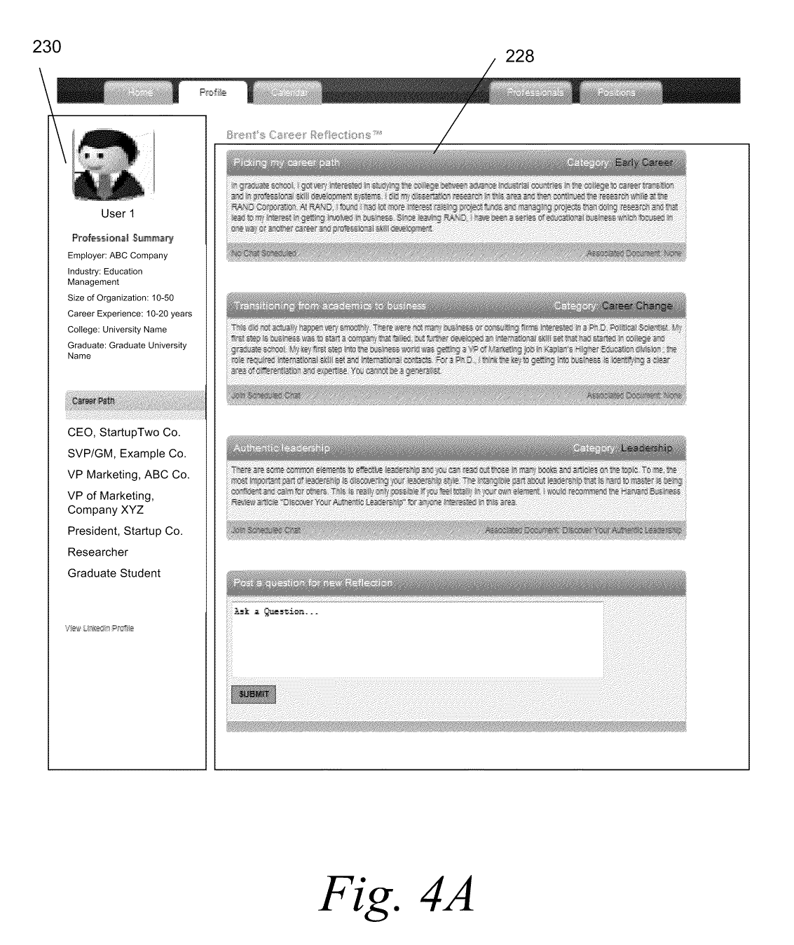

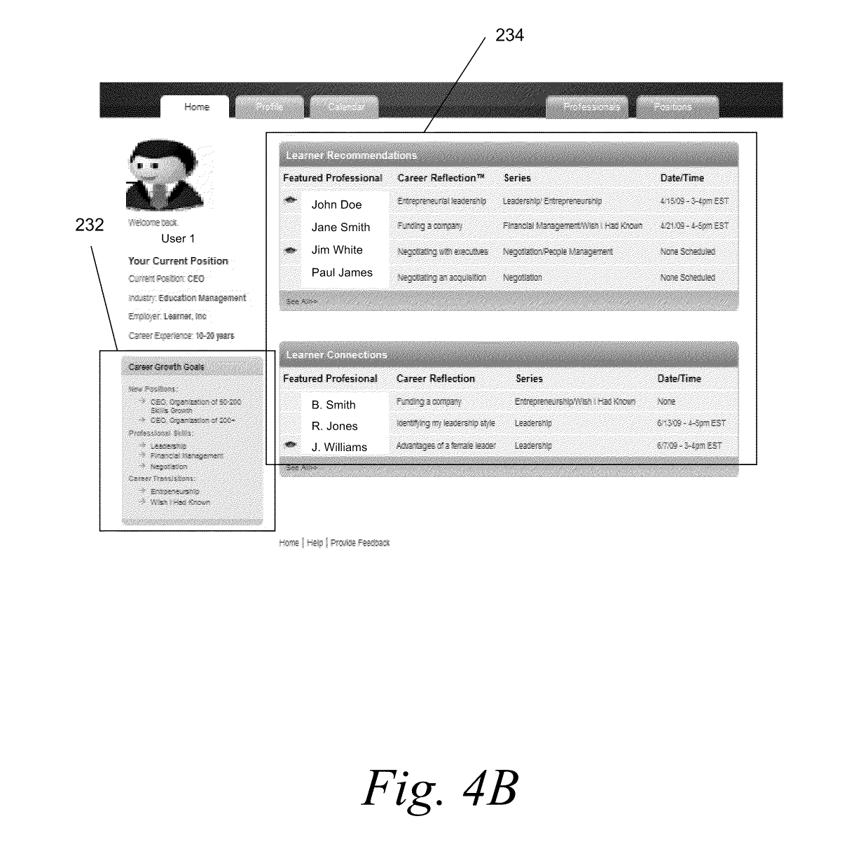

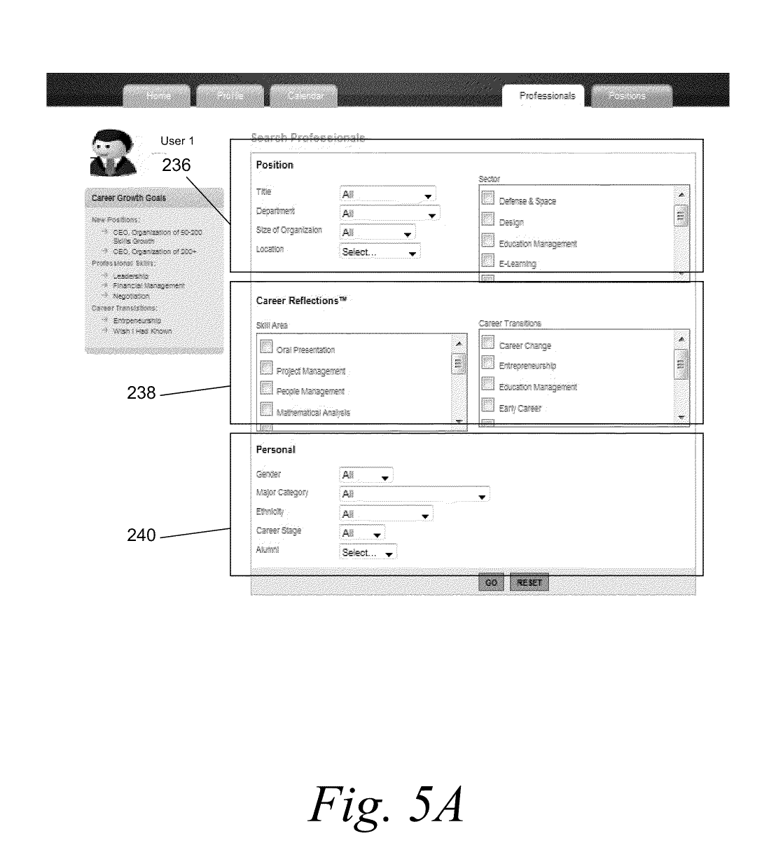

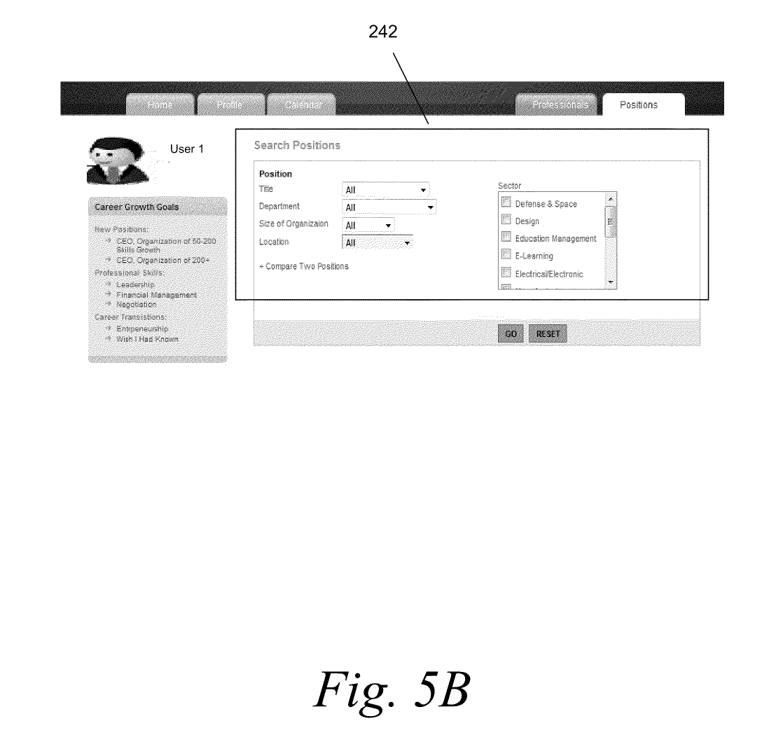

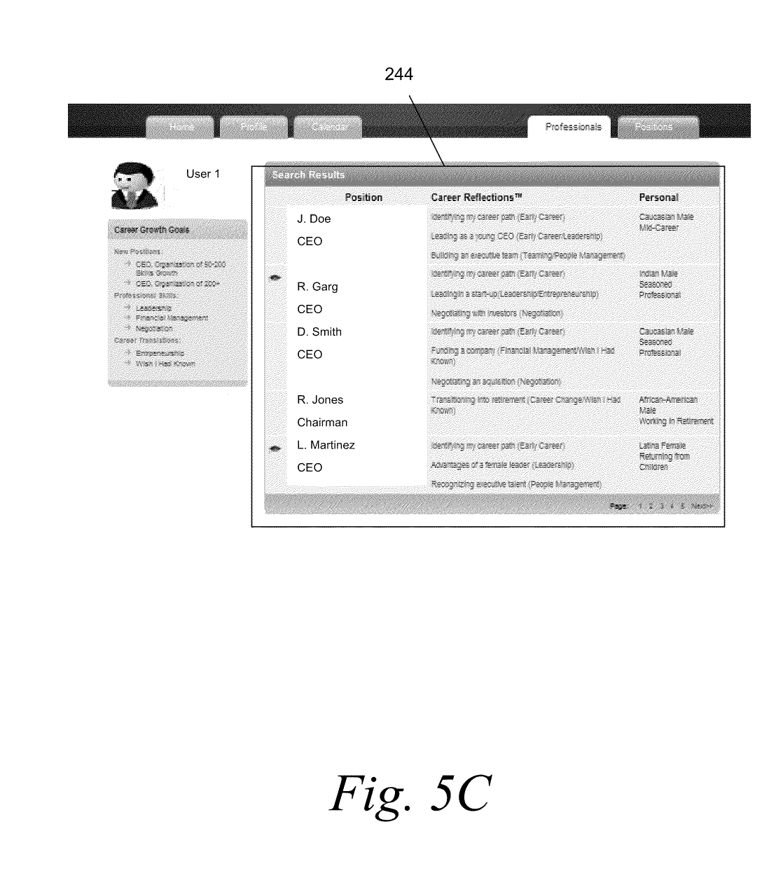

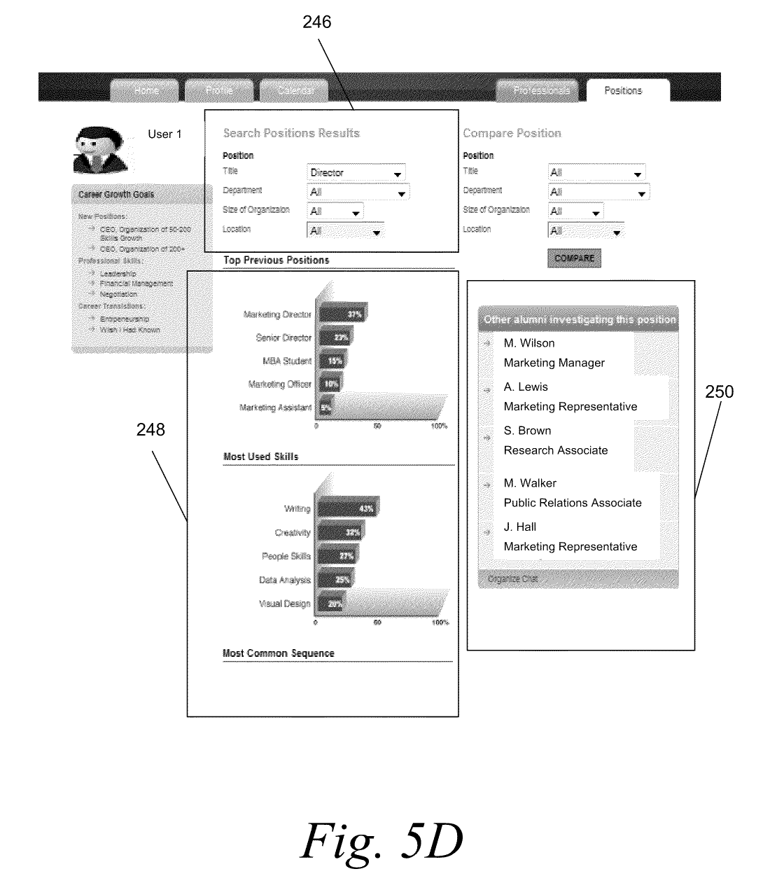

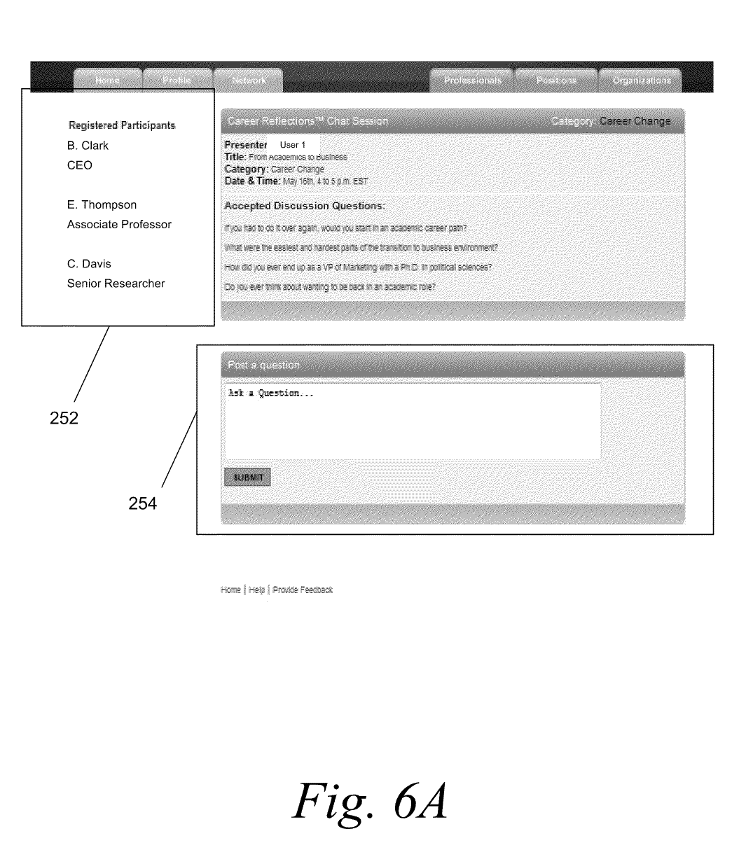

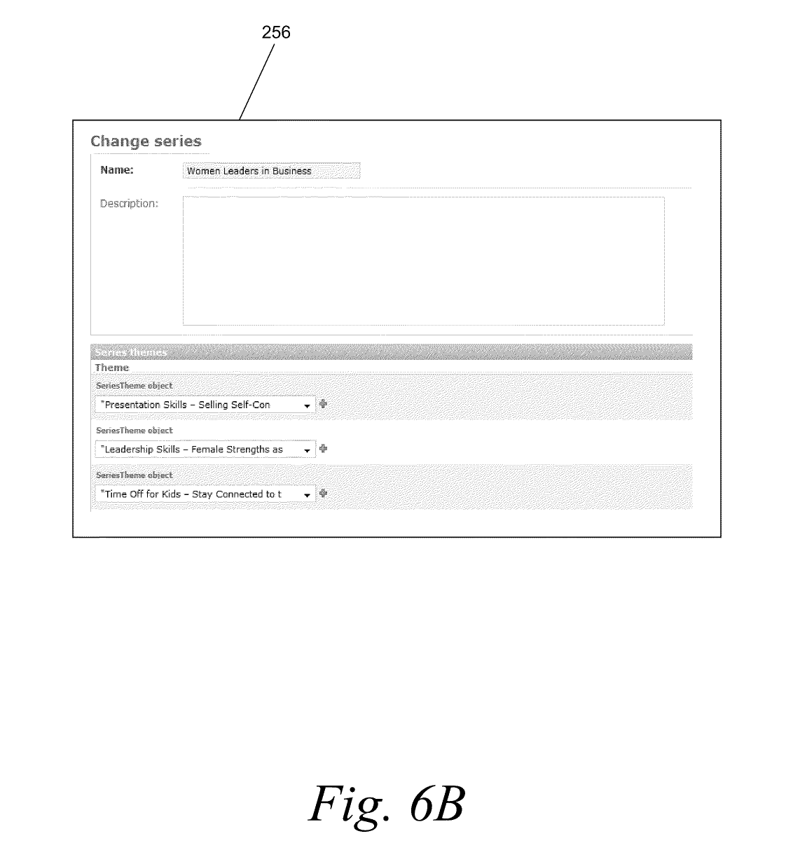

In some embodiments, a user interface generation engine 206 generates user interfaces to facilitate a matching process; examples of the generated user interfaces are described in additional detail in connection with FIGS. 3A-6B. In one embodiment, the user interface generation engine 206 generates a user interface allowing a user to modify information associated with a profile (e.g., FIG. 3D). In another of these embodiments, the user interface generation engine 206 generates a user interface allowing a user to view a publicly available profile (e.g., FIG. 4A). In another of these embodiments, namely, FIG. 4B, the user interface generation engine 206 generates a user interface allowing a user to view a private profile (e.g., a profile that is not available to all users). In another embodiment, the user interface generation engine 206 generates a user interface displaying, to a user, at least one professional profile identified as a result of a direct search of the profile database (e.g., FIG. 5C). In another embodiment, the user interface generation engine 206 generates a user interface displaying at least one profile identifying a position held by a professional identified as a match with a user (e.g., FIG. 5D). In yet another embodiment, the user interface generation engine 206 generates a user interface displaying scheduled and unscheduled opportunities for communication between matched professionals (e.g., FIGS. 6A and 6B).

In some embodiments, the user interface generation engine 206 includes a web server with which to transmit data representing a generated user interface to a computer 102, which displays the user interface to a user of the system. In other embodiments, the user interface generation engine 206 receives an instruction to generate a user interface for display to a client 102 from one of the profile generation and enhancement engine 202, the session management component 208, and the recommendation and matching engine 204. In further embodiments, the user interface generation engine 206 receives information from a user of a client 102. In one of these embodiments, the user interface generation engine 206 forwards the received information to one of the profile generation and enhancement engine 202, the session management component 208, and the recommendation and matching engine 204.

In one embodiment, the session management component 208 coordinates a session within which matched professionals may communicate. In one embodiment, the session management component 208 establishes synchronized network-based sessions between professionals; for example, the professional may communicate in real-time. In another embodiment, the session management component 208 establishes asynchronous network-based sessions between users. In still another embodiment, the session management component 208 establishes audio conferencing sessions, independent of or in combination with network-based chat sessions.

In one embodiment, the session management component 208 links individual communication sessions in a series of featured communication sessions focused on a specific type of professional. In another embodiment, the session management component 208 involves a collaborative communication session between a group of users of a second type who can provide peer input and advice on job search strategies. In still another embodiment, the session management component 208 involves communication sessions between one of more users of the second type and a user o of the first type who provides career advising through a review and response to the public profiles of the users of the second type. In some embodiments, the session management component 208 provides a mechanism for solicitation of payment from users of a second type. In still other embodiments, the session management component 208 provides a mechanism to solicit sponsorships or advertisements. In still other embodiments, the session management component 208 allows a user of a first type to post links to current activities and involvements during a communication session being led by that user. In some embodiments, the session management component 208 includes a messaging service with which to establish a session between users. In one of these embodiments, the session management component 208 includes an instant messenger service providing a real-time text messaging service for exchanging text between two computers connected over a network. In another of these embodiments, the session management component 208 leverages a publicly available instant messenger service such as, for example, one of the following: Windows Live Messenger, AOL Instant Messenger, Yahoo! Messenger, Skype, Google Talk, .NET Messenger Service, Jabber, QQ, Excite/Pal iChat, ICQ, Gadu-Gadu, and Qnext. In still another of these embodiments, the session management component 208 provides a session over an Internet Relay Chat channel. In yet another of these embodiments, the session management component 208 provides a session within a UNIX-based system, such as a service using the UNIX “talk” command. In further embodiments, the session management component 208 provides a session that supports connections from multiple protocols. In other embodiments, the session management component 208 provides a session complying with a Session Initiation Protocol (SIP) standard or a SIP for Instant Messaging and Presence Leveraging Extensions (SIMPLE) standard.

In other embodiments, messaging protocols with which the session management component 208 establishes sessions include, but are not limited to, protocols such as the Internet Relay Chat (IRC) protocol, the Microsoft Network (MSNP) protocol used by clients such as the Microsoft WINDOWS LIVE MESSENGER, the Oscar protocol used by clients such as America OnLine INSTANT MESSENGER and the ICQ instant messenger, the Protocol for Synchronous Conferencing (PSYC), the Extensible Messaging and Presence Protocol (XMPP) used by JABBER clients such as the Google GTALK client, the YAHOO! MESSENGER (YMSG) protocol, the SKYPE protocol, or protocols for sending instant messages to mobile client devices over wireless networks.

In one embodiment, the session management component 208 includes a messaging gateway. In another embodiment, a web server in communication with the session management component 208 includes a messaging gateway. In still another embodiment, a messaging gateway is provided by software executing on the server 106. In still even another embodiment, the messaging gateway is provided by a CGI script executing in a web page displayed to a user of a client 102 and forwarding user input to the session management component 208. In yet another embodiment, a messaging gateway is a router accessible to the server 106 via a network 104.

In one embodiment, the profile database 210 stores and maintains records of at least one user profile. In one embodiment, the profile database 210 stores at least one record of a profile. In another embodiment, the profile database 210 stores an identification of whether a profile is to be maintained as a private profile (e.g., require completion of an authentication process prior to viewing of the profile) or may be made publicly available. In still another embodiment, the profile database 210 stores at least one record of a position profile. In still even another embodiment, the profile database 210 stores position progression information. In yet another embodiment, the profile database 210 organizes records for display of organizational profiles for organizations employing a plurality of professionals.

In some embodiments, the profile database 210 stores data in an ODBC-compliant database. For example, the database may be provided as an ORACLE database, manufactured by Oracle Corporation of Redwood Shores, Calif. In other embodiments, the database can be a Microsoft ACCESS database or a Microsoft SQL server database, manufactured by Microsoft Corporation of Redmond, Wash. In still other embodiments, the database may be a custom-designed database based on an open source database such as the MYSQL family of freely-available database products distributed by MySQL AB Corporation of Uppsala, Sweden, and Cupertino, Calif.

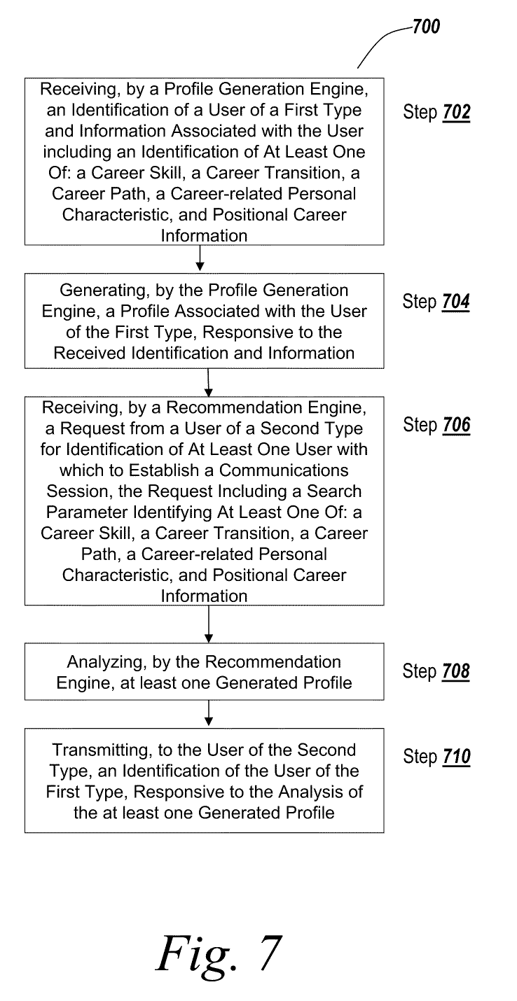

Referring now to FIG. 7, a flow diagram depicting one embodiment of a method for identifying professional networking matches via an Internet platform. The method 700 includes receiving, by a profile generation engine, an identification of a user of a first type and information associated with the user including an identification of at least one of: a career skill, a career transition, a career path, a career-related personal characteristic, positional career information, networking goal, and employer characteristics (step 702). The method includes generating, by the profile generation engine, a profile associated with the user of the first type, responsive to the received identification (step 704). The method includes receiving, by a recommendation engine, a request from a user of a second type for identification of at least one user with which to establish a connection, the request including a search parameter identifying at least one of: a career skill, a career transition, a career path, a career-related personal characteristic, positional career information, networking goal, and employer characteristics (step 706). The method includes analyzing, by the recommendation engine, at least one generated profile (step 708). The method includes transmitting, to the user of the second type, an identification of the user of the first type, responsive to the analysis of the at least one generated profile (step 710).

Referring now to FIG. 7, and in greater detail, the method includes receiving, by a profile generation engine, an identification of a user of a first type and information associated with the user including an identification of at least one of: a career skill, a career transition, a career path, a career-related personal characteristic, positional career information, networking goal, and employer characteristics (step 702). In one embodiment, the profile generation and enhancement engine 202 receives the information via a user interface generated by the user generation engine 206. In another embodiment, the profile generation engine transmits to the user interface generation engine 206 an instruction to display one or more user interfaces with which a user may enter information.

Referring still to FIG. 7, and in connection with FIGS. 3A-3D that depict exemplary screenshots of user interfaces for receiving profile information from a user, the profile generation and enhancement engine 202 can receive an identification of a user of a first type and information associated with the user including an identification of at least one of: a career skill, a career transition, a career path, a career-related personal characteristic, and positional career information. In FIG. 3A, the interface element 220 depicts one embodiment of a user interface to enter background information that includes but may not be limited to educational information, personal information, positional career information, and career path information. In another embodiment, personal information can be entered directly by the user or be pre-populated by an organization associated with the user. FIG. 3B depicts an embodiment of an interface element 222 allowing a user to enter information related to career progression. In one embodiment, information on career progression may include but is not limited to information on career skills, organizational influences on career progression, career transitions resulting from career progression, information on planning career paths, and new positions a user is interested in exploring to further progress in their career. In another embodiment, a user is able to enter information about strengths and opportunities for improvement relative to career skills and organizational influences on their progression. FIG. 3C depicts one embodiment of an interface element 224 allowing a user to enter a career narrative related to a user's career successes and progression. In one embodiment, the career narrative may be referred to as “CAREER REFLECTIONS”. In another embodiment, the career narrative is limited to a predefined length (e.g., limited to a predetermined number of words or lines). In still another embodiment, the career narrative may be related to a career experience including but not limited to developing a career skill, planning a career path, or managing a career transition. FIG. 3C interface element 226 shows one embodiment of how users might set permissions to access to data stored in a profile and to participate in communication sessions. In another embodiment, users can invite and accept invitation from others to participate in communication sessions around a career narrative and to post related documents, media and data. FIG. 3D depicts an exemplary screenshot 231 from which a user can edit profile information.

The method includes generating, by the profile generation and enhancement engine 202, a profile associated with the user of the first type, responsive to the received identification (step 704). In one embodiment, the profile generation and enhancement engine 202 generates the profile. In another embodiment, the profile generation and enhancement engine 202 stores the received information. In still another embodiment, the profile generation and enhancement engine 202 transmits the received information to the profile database 210 for storage. Referring still to FIG. 7, and in connection with FIGS. 4A and 4B that depict screen shots of embodiments of interfaces for viewing profiles, in one embodiment, a public and private profile system displays a profile generated from data entered into the profile generation engine for at least one user. FIG. 4A depicts an embodiment of the received identification as a public profile with interface element 228 showing one embodiment of the presentation of career narratives, associated documents, and schedule communication sessions, and interface element 230 showing an embodiment of a career summary and a career path. In other embodiments, the public profile would allow a user to share more detailed and quantitative information related to career progression, alternative skill paths, and skill development strategies. FIG. 4B shows one embodiment of the received identification as a private profile. In this embodiment, interface element 232 highlights a representation of received career growth goals related to new career positions, career paths, skill development strategies, and managing career transitions generated from received user data entered into the profile generation and enhancement engine 202. FIG. 4B also depicts one embodiment of an interface element 234 depicting indirect matches identified by the recommendation and matching engine 204.

The method includes receiving, by a recommendation and matching engine 204, a request from a user of a second type for identification of at least one user with which to establish a connection, the request including a search parameter identifying at least one of: a career skill, a career transition, a career path, a career-related personal characteristic or positional career information (step 706). Referring still to FIG. 7, and in connection with FIGS. 5A-5D that depict screen shots of embodiments of interfaces for a user to post requests, the method for requesting matches with a user of a second type to establish a communication session draws on the user interface engine 206 to connect users to the recommendation and matching engine 204. FIG. 5A depicts one embodiment of a user interface for making a request for a direct match with other professionals. FIG. 5A depicts one embodiment of an interface element 236 displaying a plurality of criterion for use in making a request for a direct match by drawing on positional career information including title, department, size of organization, and occupational sector. As shown in FIG. 5A, an interface element 238 depicts one embodiment of a set of search criterion which allows a user to request a direct match by drawing on career narratives around career skill development, career path planning, and/or career transitions. The interface element 240 depicts one embodiment of a set of search criterion which allows a user to request a direct match by drawing on career-related personal characteristics.

FIG. 5B depicts another embodiment of a user interface for requesting an indirect match to other professionals through a search of position profiles. FIG. 5B shows one embodiment of an interface element 242 presenting options to search on position profiles, and the profiles of associated professionals, by title, department, size of organization, and occupational sector. In still other embodiments, a user can make a request for an indirect match through the user interface engine 206 by searching organizations and companies to receive profiles of associated professionals. In still another embodiment, a user can make a request for an indirect match through a user interface engine 206 by search on types of communications sessions to receive profiles of associated professionals.

The method includes analyzing, by the recommendation and matching engine 204, at least one generated profile (708). Referring still to FIG. 7, and in connection with FIGS. 5A-5B that depict embodiments of interfaces for requesting user profiles, the method for analyzing profiles in the profile database 210 in one embodiment draws on search criterion including career development strategies, career transitions, career paths, positional career information, and career-related personal characteristics. In the embodiments depicted therein, the analysis of profiles in the profile database 210 is based on an exact match to all search parameters received via the user interface engine 206. In other embodiments, the analysis of profiles in the profile database 210 is based on a partial match to one or more of the search parameters received via the user interface engine 206. In still other embodiments, the analysis of profiles in the profile database engine 206 is based on prioritized or weighted match to the search parameters received via the user interface engine 206 with a user able to identify those search criterion which have the highest importance in displaying results. In still another embodiment, the analysis of profiles in the profile database engine 206 is based on a paired match of two paired search parameters received via the user interface engine 206 with a user able to identify the individual search criterion in the pair which has the highest importance in displaying results. In yet still another embodiment, the analysis of profiles in the profile database engine 206 is based on an indirect match to search parameters received via the user interface engine 206 as part of a search for a position profile, organizational profiles, or session type. In still other embodiments, the analysis of profiles in the profile database engine 206 is based on an indirect match to search parameters received via the user interface engine 206 as part of a search of any career-related positional or personal characteristics.

The method includes transmitting, to the user of the second type, an identification of the user of the first type, responsive to the analysis of the at least one generated profile (step 710). Referring still to FIG. 7, and in connection with FIGS. 5C and 5D that depict screen shots of embodiments of interfaces transmitting an identification to a user, the interface 244 transmits the identification to the user resulting from the analysis of the profile database 210 generated by the recommendation and matching engine 204. In one embodiment depicted in FIG. 5C an interface element 244 depicts an interface for transmitting the results of professionals matched through a direct search of profile database 210 to a user of a second type. In another embodiment, FIG. 5D depicts an embodiment of a method for transmitting results of an indirect match of a professional to a user of a second type. In this embodiment, professionals are matched in response to the search of a career position as shown in FIG. 5D by interface element 246, with the resulting display of statistical information on a career position as shown in interface element 248 and a display of other professionals investigating this position as shown 250. In another embodiment, results of indirect matches generated through the recommendation and matching engine 204 are presented in a user's private profile page. In still another embodiment, results of indirect matches generated through the recommendation and matching engine 204 are displayed through elements of the user interface engine 206 that represent organizational profiles.

In another embodiment, the transmission of user profiles is responsive to levels of authorization set by a user of the first type. In some embodiments, a user can authorize access to date in a profile. In another embodiment, a user can authorize participation or solicitations for joining communication session. In still other embodiments, a user can authorize the release of personal contact information following participation in a communication session.

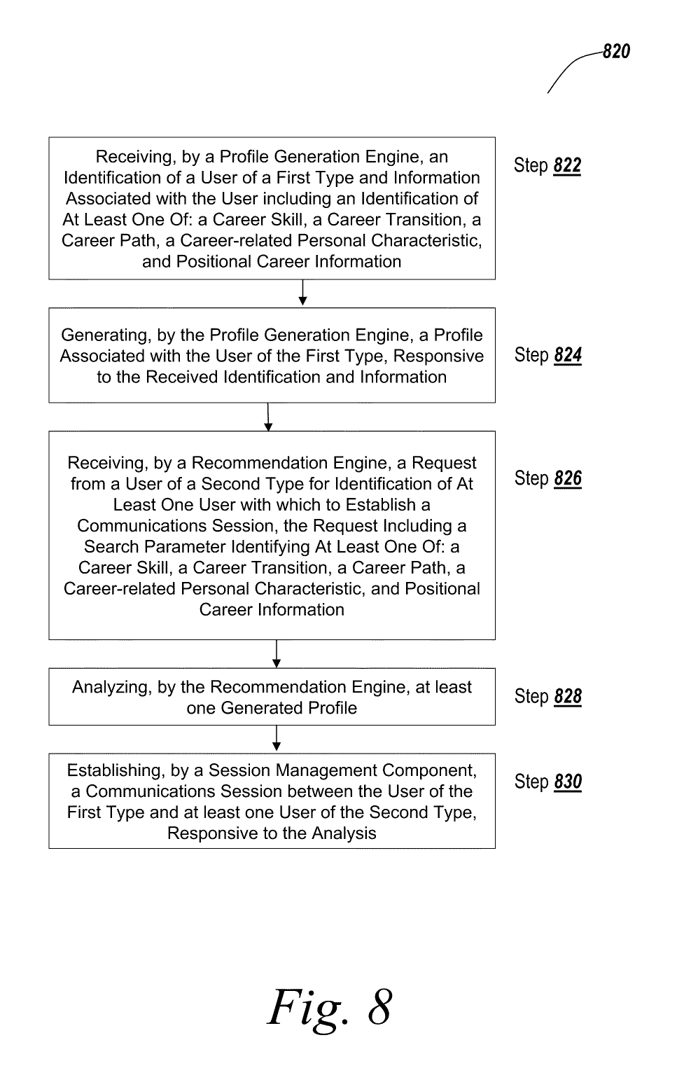

Referring now to FIG. 8, a flow diagram depicting another embodiment of a method for career development for matched professionals via an Internet platform. The method 820 includes receiving, by a profile generation engine, an identification of a user of a first type and information associated with the user including an identification of at least one of: a career skill, a career transition, a career path, a career-related personal characteristic and positional career information (step 822). The method includes generating, by the profile generation engine, a profile associated with the at least one user and storing the received identification (step 824). The method includes receiving, by a recommendation engine, a request from a user of a second type for identification of at least one user with which to establish a connection, the request including a search parameter identifying at least one of: a career skill, a career transition, a career path, a career-related personal characteristic or positional career information (step 826). The method includes analyzing, by the recommendation engine, at least one generated profile (step 828). The method includes establishing, by a session management component, a communications session between the user of the first type and at least one user of the second type, responsive to the analysis (step 830).

The method 820 includes receiving, by a profile generation engine, an identification of a user of a first type and information associated with the user including an identification of at least one of: a career skill, a career transition, a career path, a career-related personal characteristic and positional career information (822). In one embodiment, the profile generation and enhancement engine 202 receives the identifications as described above in connection with FIG. 7, step 702.

The method includes generating, by the profile generation engine, a profile associated with the user of the first type, responsive to the received identification (step 824). In one embodiment, the profile generation and enhancement engine 202 generates the profile as described above in connection with FIG. 7, step 704.

The method includes receiving, by a recommendation engine, a request from a user of a second type for identification of at least one user with which to establish a connection, the request including a search parameter identifying at least one of: a career skill, a career transition, a career path, a career-related personal characteristic or positional career information (step 826). In one embodiment, the recommendation and matching engine 204 receives the request as described above in connection with FIG. 7, step 706.

The method includes analyzing, by the recommendation engine, at least one generated profile (step 828). In one embodiment, the recommendation and matching engine 204 analyzes the at least one generated profile, as described above in connection with FIG. 7, step 708.

The method includes establishing, by a session management component 208, a communications session between the user of the first type and at least one user of the second type (step 830). Referring still to FIG. 8, and in connection with FIGS. 6A and 6B that depict embodiments of interfaces for a session management, in one embodiment, the session management component 208 establishes a session between the user and each session participant in a plurality of session participants upon authenticating the user. In another embodiment, and as depicted in FIG. 6A, an interface element 252 includes functionality for requesting from the session management component 208 establishment of a session between the user and each of the session participants upon authenticating the user and each of the session participants. In some embodiments, and as depicted in FIG. 6A, an interface element 254 provides functionality for requesting authorization, from the session management component 208, to post questions to a presenter as part of a communication session. In one of these embodiments, a user has an account that authorizes the user to access one or more of the communication services provided by the system based on their account type. In another of these embodiments, the user does not have an account with the system, but is able to access selected communication sessions. In still another of these embodiments, the session management component 208 provides a different level of service to users with accounts than a level of service received by users without accounts.

Referring now to FIG. 6B, the figure depicts a screen shot of one embodiment of a session management interface 256 allowing a user, such as an administrator, to sequence communications sessions into series. In some embodiments, the session management component 208 sequences communications sessions to establish series targeted to users of a second type meeting a specific profile. In one embodiment, a sequence of communication sessions may target skill development strategies, career path planning strategies, or strategies for managing a career transition for a targeted group of individuals with similar career-related personal or positional career characteristics. In another embodiment, a sequence of communication sessions may target a group of inquiring professionals or aspiring professionals interested in exploring the same career position. In still another embodiment, a sequence of communication sessions may involve a group of peers working on a common project or common problem related to career performance or progression.

Further, the system of FIG. 2 can be used to identify career-related events for a user of the career development networking service and/or match the user with attendees of career-related events who meet networking criteria. In operation, in addition to receiving profile information inputted from users, as described in reference to FIG. 2, the profile generation and enhancement engine 202 can receive profile information of users through various other avenues. For example, users can transfer profile information from third-party websites. In some embodiments, users can provide the networking service with the address of third-party websites associated with the user and/or login information for such websites. The server 106 can access the third-party websites to obtain information about the user for the user's profile. The server 106 can derive information from posts or other activities made by the users on their accounts with the third-party websites. The third-party websites can be any website with information about the user. For example, the third-party websites can be social media websites, such as Facebook, MySpace, LinkedIn, Geni.com, Hi5, Ning, Orkut, Skyrock, Qzone, Vkontakte, RenRen, Kaixin, ASmallWorld, studivz, Xing, RunAlong.se, Bebo, BigTent, Elgg, Hyves. In further examples, the third-party websites can be information dissemination sites, such as blogs or micro-blogs like Blogger, LiveJournal, Open Diary, TypePad, WordPress, Vox, ExpressionEngine, Xanga, Jaiku, Plurk, Twitter, Tumblr, Posterous, Yammer, and/or Qaiku. However, such third-party websites are not limited to the examples disclosed herein, but can extend to any platform as would be appreciated by one of ordinary skill in the art.

The profile generation and enhancement engine 202 can also receive profile information of users from organizations such as event providers, the networking system administrator, or other clients of the career development networking service. These entities can enter profile information about users through, for example, data entry. Clients of the networking service, such as companies, universities, trade associations, or any other organization can input profile information for members of their organizations. Event providers can input profile information of users to the service based on registration lists for career-related events. In some embodiments, event providers can integrate event registration sites with the career development networking service. In this manner, when users register for events, their profile information can be imported into the career development networking service. The service can evaluate its profile database for pre-existing entries. If the profile database already includes a profile for the user, the networking service can augment the user's profile with information provided during registration for the event. Otherwise, the networking service can create a new profile for the user. The profile information for each user can be stored in the profile database 210.

In addition to the profile information described in reference to FIG. 3A-3D, the profile information can include any other type and kind of information. The profile information can include the user's name, employer, title, and geographical location. The profile information can include the user's undergraduate school, graduate school or schools, and past employers. The profile information can include professional organizations the user has joined and/or alumni organizations the user belongs to. The profile information can include past events the user has attended, such as industry expos, industry events, and/or social or community events (e.g., volunteer events, sporting events, musical events, artistic events). The profile information can include general information about the user's interests, both professional and personal.

In many embodiments, the profile information can include networking objectives and/or preferences of the user. Exemplary objectives can include job searching, seeking professional advice, seeking legal advice, and transitioning careers. Additional exemplary objectives can include staff recruiting, investigating supplier and vendor relationships, looking for business partners, looking for consultants, looking for investors, and looking to make investments.

The user can assign priority levels to objectives. For example, if a user owns a start-up company and needs additional funding, the user can assign the objective “looking for investors” a high priority. If the user's company is currently understaffed, the user can assign the objective “looking for talent” a high priority. If the user's company obtains the necessary funding and hires sufficient employees, the user can then assign these objectives lower priorities. As the user's company progresses in research and development, the user may decide the company needs to find another company that already has expertise in a particular field. If the user becomes interested in finding a company for joint research, the user can set the objective “looking for a business partner” to a high priority.

In some embodiments, the networking service assigns the objectives equal priority levels until the user changes the priority levels. In other embodiments, the networking service assigns the objectives priority levels based on profile information about the user. For example, if the user is a CEO of his company, the networking service can assign low or negligible priorities to objectives about career transitioning or job seeking and higher priorities to looking for business partners or consultants. If the user's job title indicates the user recently began his career, the networking service can assign “looking for advice” a high priority.

The profile generation and enhancement engine 202 can enhance the profiles of users by generating or obtaining additional information about the users. The additional information can be added to the user profiles. In some embodiments, the profile generation and enhancement engine 202 enhances the profile information by identifying skills, educational credentials, transition opportunities, and the like for acquisition based on the profile information of the user. For example, the networking service can evaluate a user's current role and aspirational role to evaluate gaps in the user's educational or degree attainment. In another example, the service can evaluate a user's current title, employer, and/or history of employment to derive the user's career focus, career path, and career level. From this information, the service can identify available career transition opportunities or possible next job/career steps. In any of these embodiments, the networking service can apply any algorithm to the user's profile information to generate additional information for the user's profile.

In some embodiments, the profile generation and enhancement engine 202 can enhance profile information of a user by retrieving information about the user from third-party servers. For example, based on the user's employer, the networking service can access a third-party database on public companies to determine the size (e.g., small-cap), number of employees, geographic locations, and professional sector of the user's employer. If the user indicates membership in a professional organization, the networking service can access the organization's website to identify leadership or committee positions the user holds or events the user has attended. From a user's name, title, and employer, the networking service can find the user's public profile on a professional networking website (e.g., LinkedIn) and import the user's employment history and educational credentials.

If the user provides a username and/or credentials for any of the third-party websites described herein, the networking service can access the user's accounts and obtain any of the information stored about the user. For example, if the user provides a URL for a blog, the networking service can derive information about the user by analyzing the text on the blog. If the networking service detects multiple postings about entrepreneurship, the service can add “entrepreneurship” as a field of interest to the user's profile. If the blog includes multiple postings on health care reform, the service may deduce that the user works in the health care sector. In some embodiments, the network service can access the user's account directly for profile information. For example, the network service can access a user's Facebook account and import information about the user's favorite music, hobbies, and movies, as well as particular artists and organizations that the user supports.

In many embodiments, the profile generation and enhancement engine 202 can enhance profile information of a user by analyzing profile information of users of the professional networking service with whom the user forms connections. In this manner, whenever a user views another user's profile, e-mails another user, takes notes on another user, adds another user as a connection on the networking service, schedules a follow-up networking meeting with another user, or any other form of engagement with another user as would be appreciated by one of ordinary skill in the art, the networking service can analyze the users' profile information. Based on this analysis, the networking service can generate additional profile information for the user.

The engine 202 can compare the skills, roles, educational credentials, or other metrics of the users that the user connects to. For example, the engine 202 can observe that the user has been connecting to professionals more advanced in their careers and add an interest in networking with professionals at that career level to the user's profile information. The engine 202 can observe that the user's most recent connections all have advanced degrees from the same institution. In response, the engine 202 can add an interest in obtaining an advanced degree and an interest in the institution to the user's profile. In another example, the user may be connecting with professionals working for mid-sized companies in a niche market. The engine 202 can add an interest in the niche market to the user's profile information. If the user has been connecting to mid-size venture capitalists, the engine 202 can add an interest in venture funding from mid-sized investors to the user's profile information. In this manner, the engine 202 can detect any pattern in the connections the user makes to generate additional information for the user's profile.

The recommendation and matching engine 204 can match the user with other users of the career development networking service based on the users' profile information. In particular, the matching engine 204 can match users based on any information or combination of information in the user's profile. In various examples, the networking service can match users based on career path and roles, network goals, and/or employer size, sector, and focus. In further examples, the networking service can match users based on professional and personal interests, as identified from event attendance, social media activity, and history of professional connections.

In some embodiments, the matching engine 204 can match a user with other users based on stated needs. In various examples, the matching engine 204 can match an investor looking for investment opportunities in small companies developing clean technology with executives of such companies who have indicated they are looking for investors. The matching engine 204 can match professionals in similar sectors who have indicated they are looking for business partners. The matching engine 204 can match users looking for advice regarding an emerging market demographic with professionals working in marketing consulting. The matching engine 204 can match users looking for jobs in particular sectors with more advanced-stage professionals at companies in those sectors.

The matching engine 204 can match users according to the priorities a user has assigned to objectives, as indicated in the user's profile. In this manner, professionals who meet the user's most important objectives or a larger number of the user's objectives can be deemed more advantageous matches than professionals who meet fewer or less important objectives. In many embodiments, the matching engine 204 computes a match score for each user in the profile database according to the user's profile information. Users who meet the user's important objectives or more of the user's total objectives can obtain higher match scores. For example, if a user has indicated that career transitioning is a high priority but looking for business partners is a lower priority, the matching engine 204 can weight more heavily users who have moved from the user's current career path to the user's aspirational career path. In this manner, such users can be deemed more advantageous matches that users with similar career roles, career levels, companies, and industries. If a user has prioritized a need for investment, the matching engine 204 can weight investors more heavily than consultants or legal advisers when identifying matches for the user. If a user is looking for a job, the matching engine 204 can weight advanced-stage professionals in the user's preferred sectors over investors, consultants, or legal advisers.

Then, the recommendation and matching engine 204 can identify a career-related event attended by a threshold number of users matched to the user. The recommendation and matching engine 204 service can identify an event with a threshold number of attendees with comparable roles and career levels as the user. If the profile generation and enhancement engine 202 observes that the user has been viewing or connecting to professionals at a more advanced career level than the user, the recommendation and matching engine 204 can identify an event with a threshold number of attendees at a more advanced career level in the user's career path or corporate recruiters seeking candidates at that career level. The recommendation and matching engine 204 can identify events with threshold numbers of attendees whose career paths match the user's own career progression interests.

In some embodiments, the recommendation and matching engine 204 can identify an event with a threshold number of attendees who can advance the user's education. For example, if the profile enhancing engine 202 observes the user connecting to professionals in a career role that requires particular educational credentials (e.g., college, graduate, or professional degree) or the user otherwise indicates an interest in the career role, the recommendation and matching engine 204 can identify an event, such as a university information session, where the user can explore obtaining the educational credentials. In another embodiment, the recommendation and matching engine 204 can identify an event being attended by alumni of degree programs of interest to the user.

In further examples, if a user is looking for investment or partnership opportunities, the recommendation and matching engine 204 can identify an event with a threshold number of attendees in leadership positions at companies in the same sector. Likewise, if a user is looking for business connections or potential sales opportunities with organizations in a certain sector, the recommendation and matching engine 204 can identify an event with a threshold number of attendees in leadership positions at companies in the desired sector.

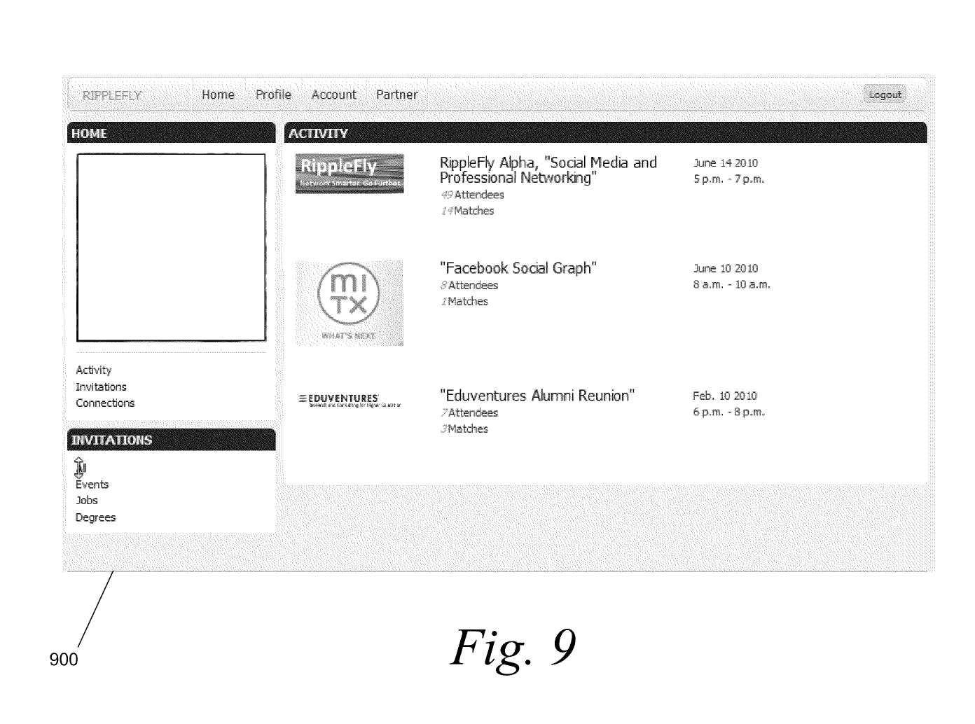

The recommendation and matching engine 204 can transmit information about the events to the user interface generation engine 206, and the user interface generation engine 206 can display the events to the user. In the embodiment of FIG. 9, the user interface generation engine 206 displays identified events in a single user interface 900. In some embodiments, the user interface generation engine 206 integrates an invitation to the event with the display of the event. In other embodiments, the recommendation and matching engine 204 can send an invitation to the event to the user via e-mail, postal mail, or any other means of communication.

For each event, the user interface generation engine 206 can display the date, time, and location of the event, the number of attendees, the number of career development matches attending the event, and/or other any information about the event. A user can view information about the attendees of the events. In some embodiments, a user must accept an invitation to the event before the user can access such information, and in other embodiments, the user can access such information before deciding to attend an event.

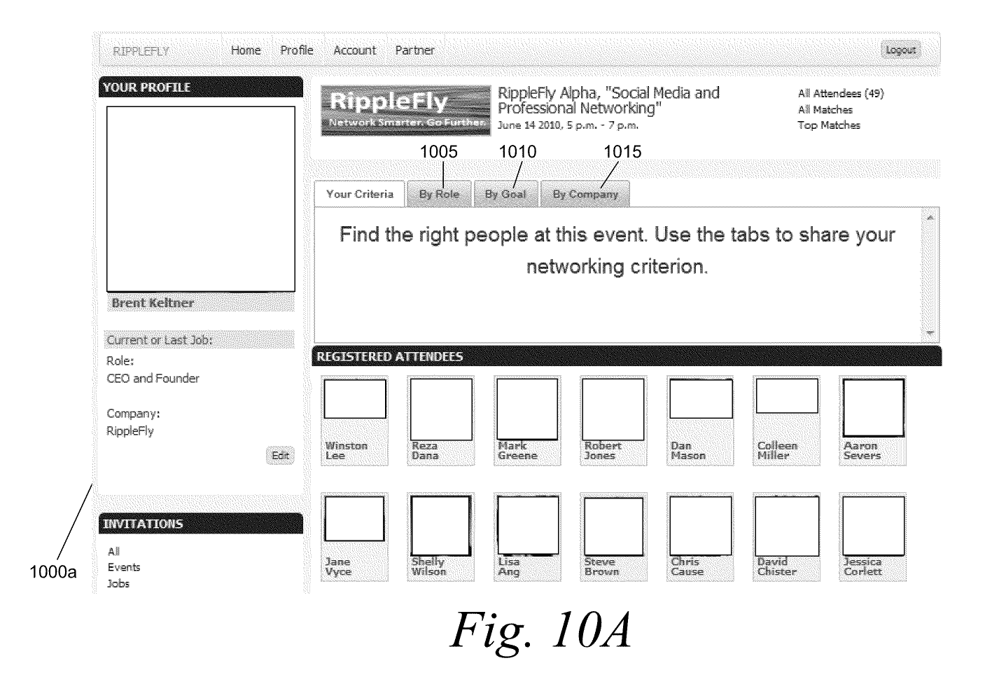

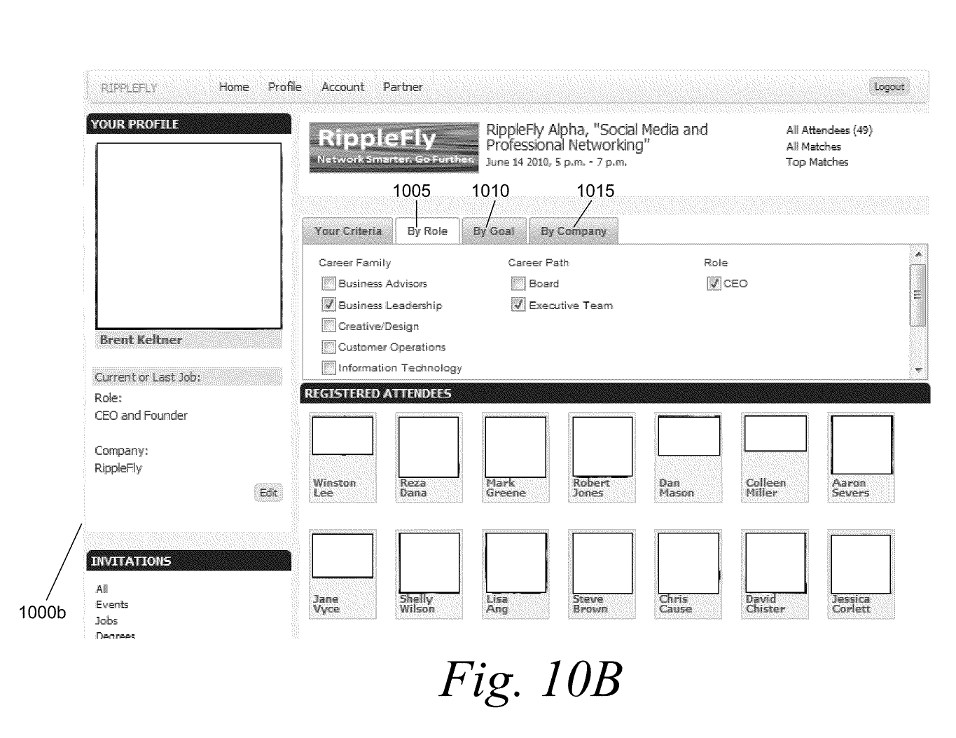

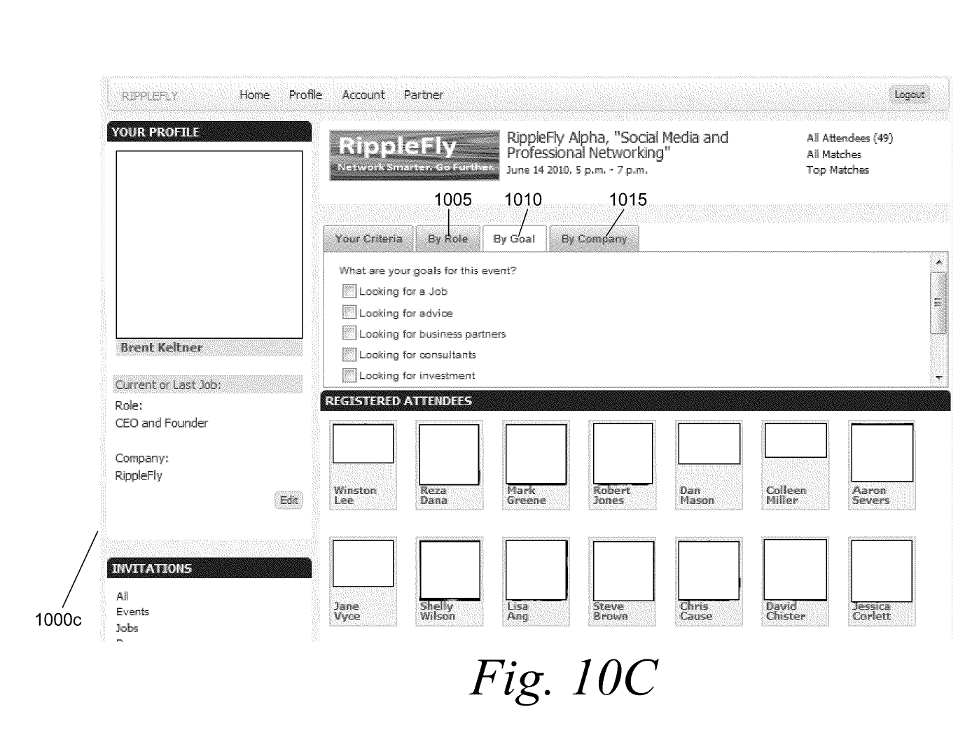

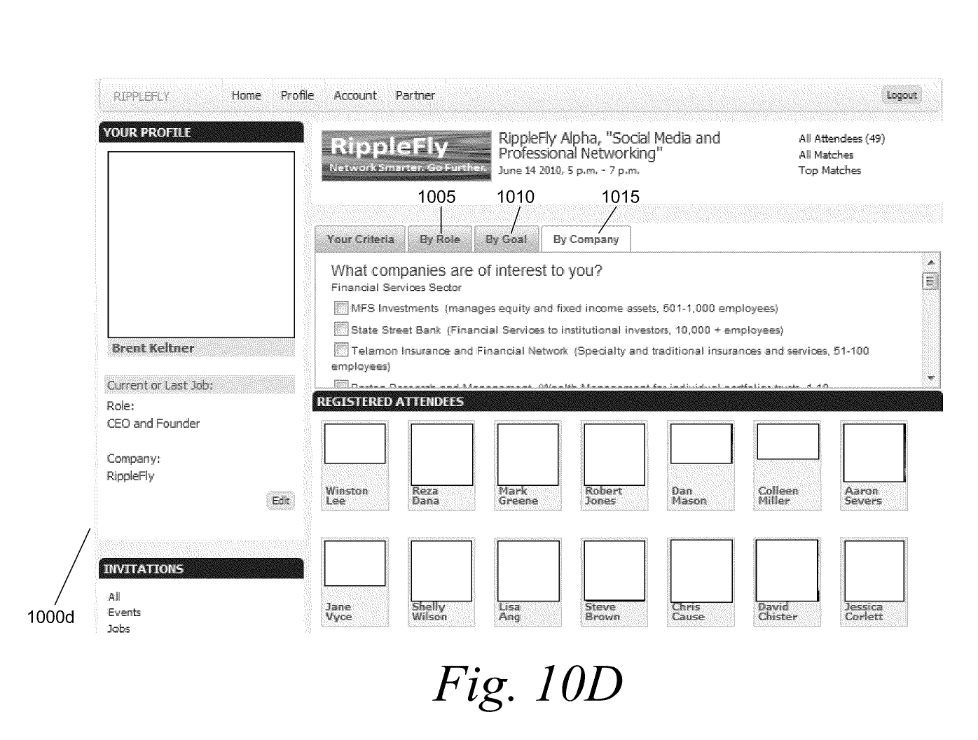

When viewing information about the attendees of an event, the user can request an enumeration of attendees according to a criterion. In the embodiments of FIGS. 10A-10D, the user can select a tab corresponding to a category of criterion (e.g., role 1005, goal 1010, company 1015). Upon selection of a tab, the user interface generation engine 206 can display criteria in that category for the user to select. In the embodiment of FIG. 10B, a user can request an enumeration of attendees with a particular role by selecting criteria regarding career path (e.g., business advisor, business leadership, creative/design, customer operations, information technology), career family (e.g., company board, executive) and/or role (e.g., CEO, CTO, CFO). In the embodiment of FIG. 10C, a user can request an enumeration of attendees with particular goals by selecting one or more goals from the list (e.g., looking for a job, advice, business partners, consultants, investments). In the embodiment of FIG. 10D, a user can request an enumeration of attendees associated with particular companies by selecting companies from a list. Although the embodiments of FIGS. 10A-10D display the criteria with check-boxes, any user interface for selecting a criterion (e.g., drop-down menu, radio button) can be used. Further, a user can select more than one criterion.

The recommendation engine 204 can identify attendees of the event that meet the criterion. For example, the recommendation engine 204 can identify such attendees by filtering the attendees according to the criterion. In particular, the recommendation engine 204 can search the attendees' profile information and identify attendees with information that matches the criterion. In some embodiments, the recommendation engine 204 can order the attendees that match the criterion by their overall match score for the user. The recommendation engine 204 can transmit to the user interface generation engine 206 a list of attendees that indicates which attendees meet the criterion. In some embodiments, the list first enumerates attendees that meet criterion followed by attendees that do not meet the criterion. In other embodiments, attendees that meet the criterion can include an indicator.

The user interface generation engine 206 creates a user interface based on the list of attendees from the recommendation engine 204. The user interface generation engine 206 can display the attendees that meet the criterion in any manner that distinguishes these attendees from the attendees that do not meet the criterion. For example, the user interface generation engine 206 can display the attendees that meet the criterion before the attendees that do not. Alternatively, the engine 206 can highlight the profile pictures of attendees that meet the criterion. Furthermore, the engine 206 can display the names of attendees meeting the criterion in bold-face type. In this manner, users can identify attendees of a career-related event to target for networking.

The user can request an enumeration of attendees of the career-related event that meet networking criteria based on the profile information of the user. In some embodiments, the display of an event permits a user to view the attendees that best meet the user's networking needs. In the embodiments depicted in FIG. 10A-10D, a user can select a link to “Top Matches” 1050. In response, the recommendation engine 204 orders the attendees based on their match scores computed according to the user's profile information. In some embodiments, the recommendation engine 204 identifies attendees with match scores equal to or higher than a threshold match score and creates a list of attendees from the identified attendees.

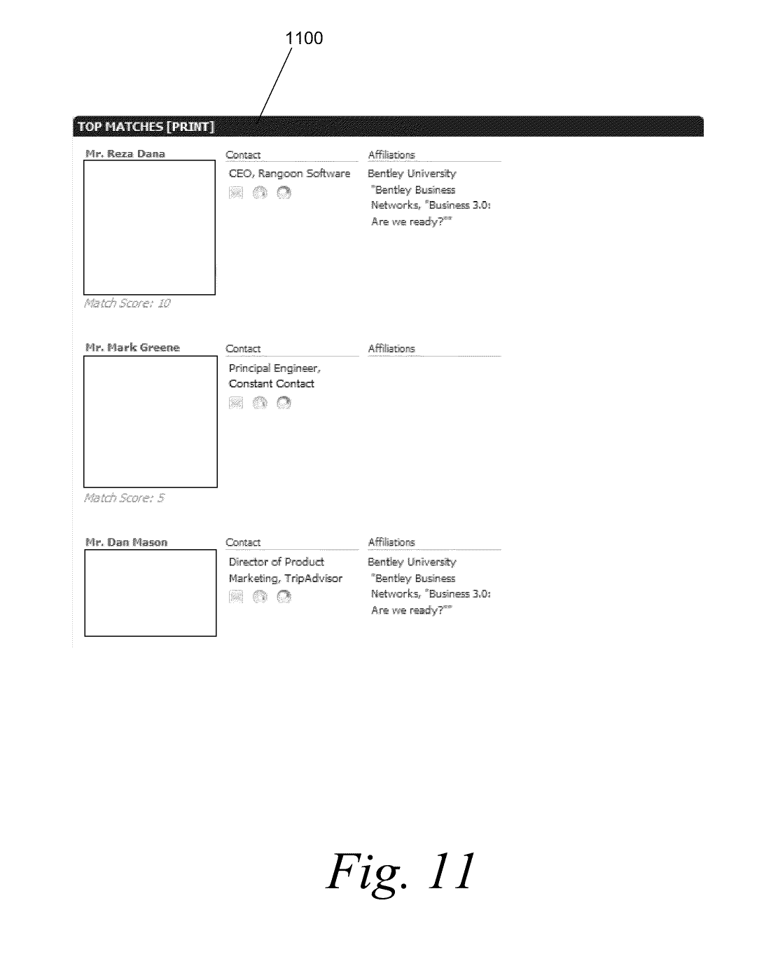

The user interface generation engine 206 generates a display of the attendees with the highest match scores. The display can include any information about the attendees, such as name, title, company, profile picture, contact information, affiliations, or any other information pertinent to networking. In some embodiments, the user interface generation engine 206 creates a display such as the screenshot depicted in FIG. 11.

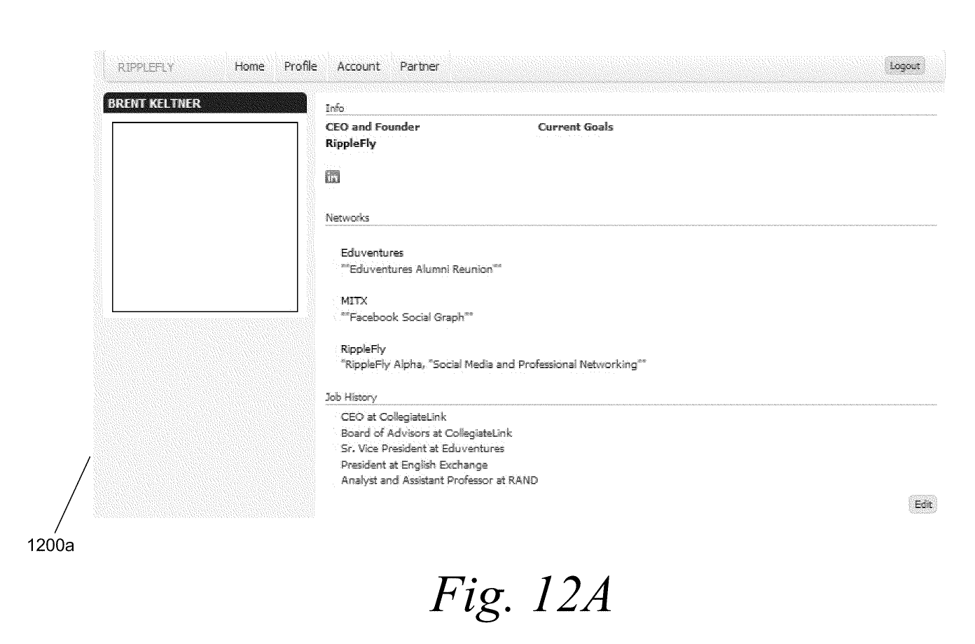

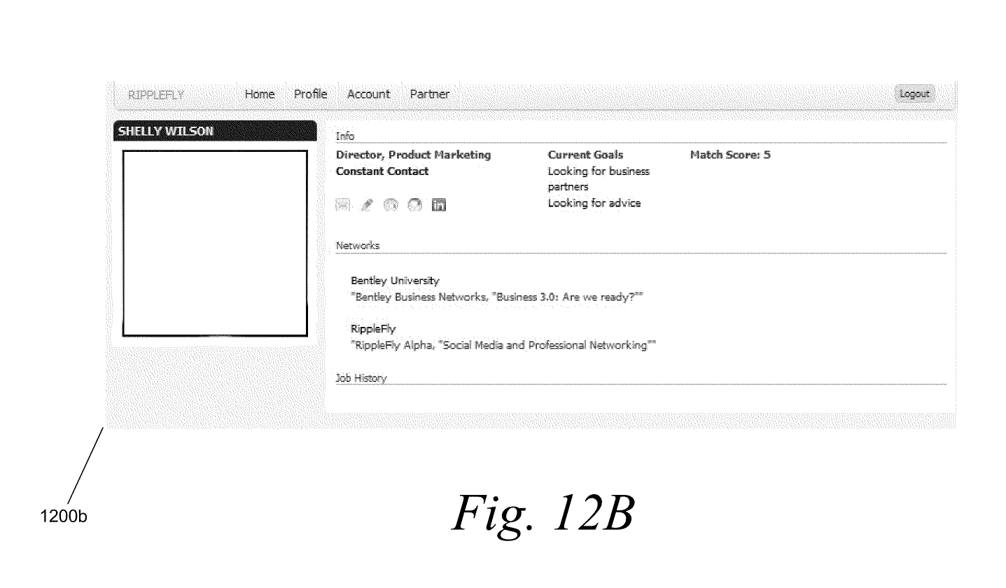

A user can select an attendee of an event to view the prospective contact's profile information. In some embodiments, when a user selects an attendee, the recommendation engine 204 obtains the selected attendee's profile information from the profile database 210 and the user interface generation engine 206 creates a display of the attendee's profile. The display can include solely the public profile of the attendee. The display can include any information the attendee has authorized to publicize on the networking service. For example, the display can include information about an attendee such as a profile picture, title, role, company, networking goals, networks, job history, and match score, as depicted in FIGS. 12A and 12B.

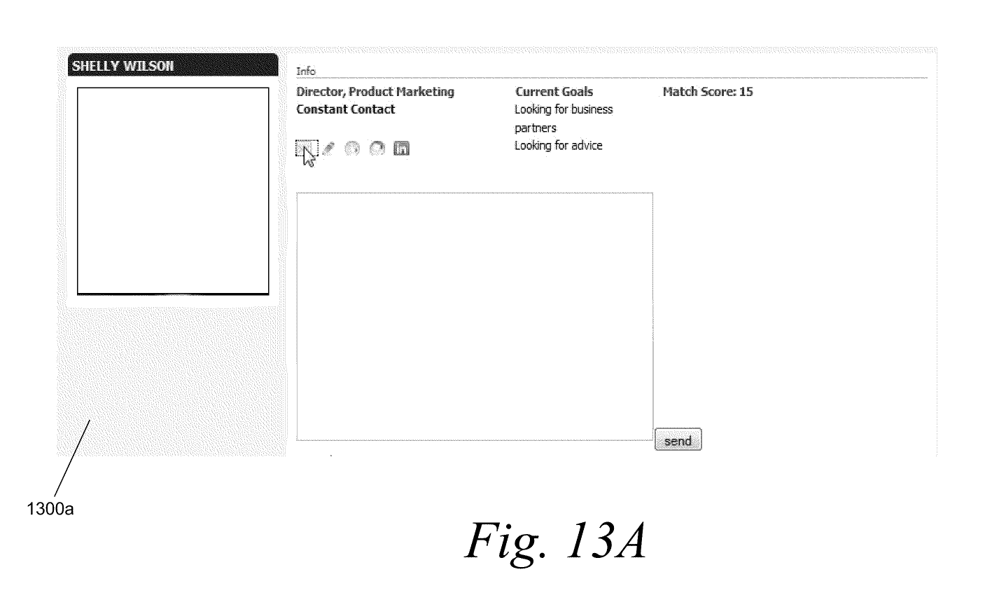

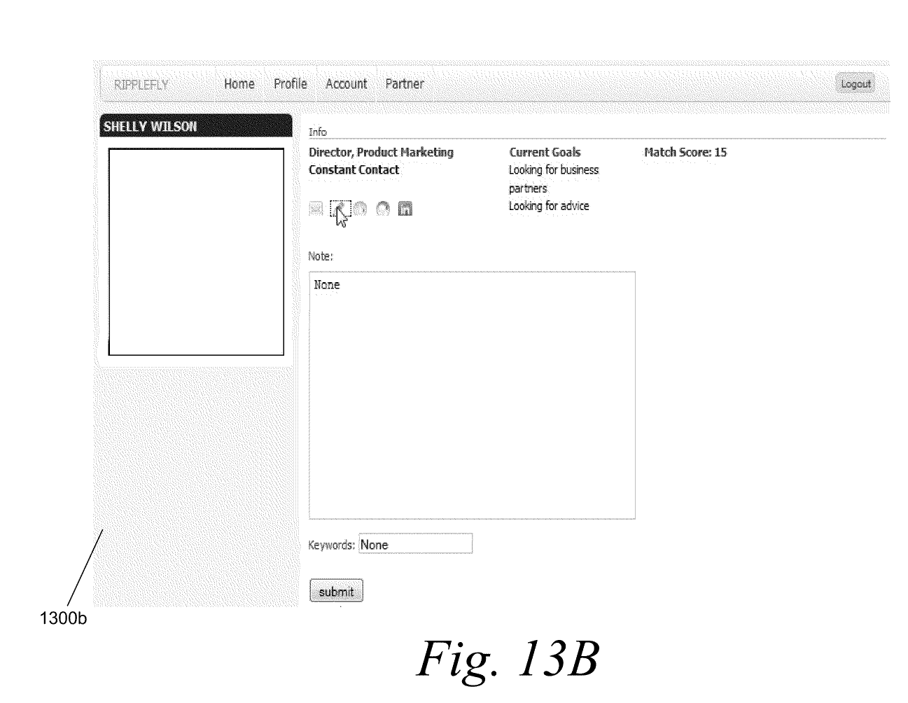

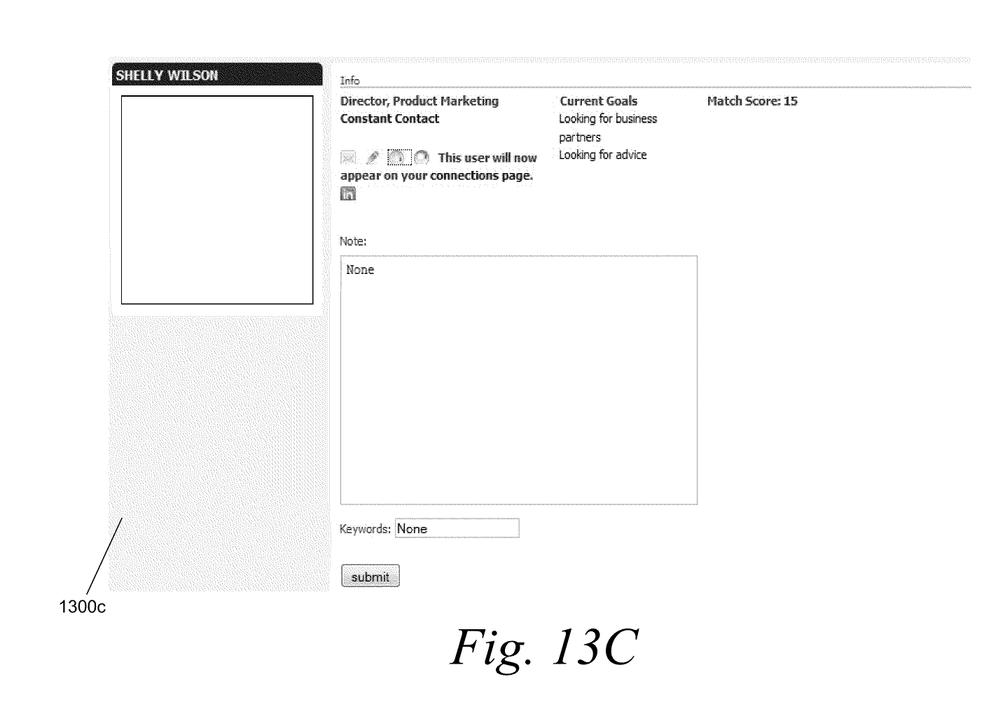

A user can create connections with the attendee from the attendee's profile information. In the embodiments depicted in FIGS. 13A-13C, a user can send a message to the attendee, create a note about the attendee, and/or add the attendee as a connection. Messages sent to the attendee can appear in an inbox on the attendee's networking service account. Notes about the attendee can be saved in the user's account. For example, after a user meets with the attendee for a follow-up networking lunch, the user can create and save a note describing the time and results of the lunch. In another example, the user can edit the note to track the resources the attendee can offer.

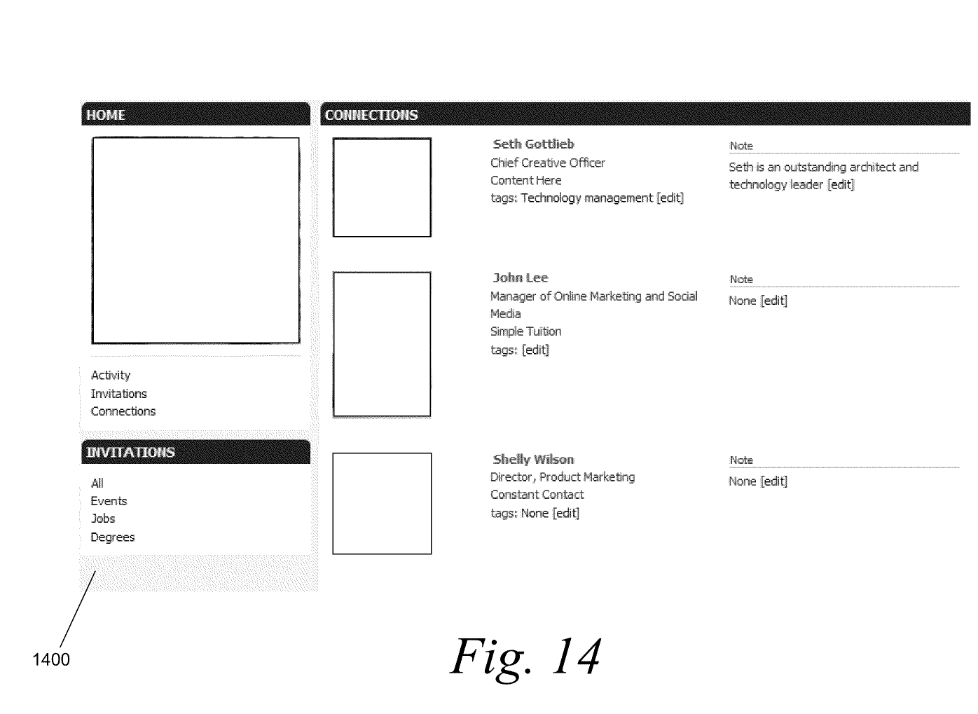

If the user wishes to begin a relationship with the attendee, the user can add the attendee as a connection. In some embodiments, the networking service sends a message to the attendee to confirm consent to the created connection. In various embodiments, the networking service can display a user's connections, as depicted in FIG. 14. This display can include any information about the connections such as their names, titles, roles, industries, profile pictures, saved notes, contact information, or any other information pertinent to networking.

In various embodiments, the networking service can provide for each user a list of matches according to the user's networking objectives. A user can access such lists from the user's profile page or other account page on the service. In some embodiments, the networking service can provide a single list of matches that represent prospective career-related networking contacts for the user. The list can order the matches by their match scores, such scores computed from analyzing the prospective contacts' profile information in light of the user's networking objectives.

The networking service can provide multiple lists of matches, each list corresponding to a unique networking objective of the user. For example, if the user's networking objectives include “looking for investors” and “looking for a career transition,” the networking service can produce one list of investors looking for prospective start-up companies in the user's sector and another list of professionals at a more advanced career level in the user's sector. In another example, if the user's networking objectives include “looking for consultants” and “looking for business partners,” the networking service can produce one list of consultants specializing in the user's sector and another list of executives managing companies of the same size and sector as the user's. Each of these lists can order the matches by match score.

The networking service can provide lists of matches corresponding to the user's affiliations and networking objectives. In this manner, the networking service can emphasize prospective career-related networking contacts with whom the user already has a connection, thereby improving the likelihood the user can form a successful relationship. For example, the networking service can identify members of the user's alma mater who meet at least one of the user's networking objectives. In another example, the networking service can identify members of one of the user's social groups who meet at least one of the user's networking objectives. The networking service can display this information in any format. For example, the networking service can display separate lists based on the user's affiliations (e.g., alumni of a user's current employer who meet a networking objective, fellow hobbyists who meet that networking objective).

In some embodiments, the organizations can input profile information of their members to the networking service and request the networking service to identify members of the organization whose networking objectives match. For example, the networking service can identify alumni of a university who are interested in career transitioning or alumni of a business school who are looking for business partners in a particular sector. In some embodiments, the organizations can form a group based on the networking objective and retain control over the group's membership and activities.

In other embodiments, the networking service can inform the identified network service users of the affiliation and networking objectives. For example, the networking service can form a group based on these criteria and invite the identified users of the service to join the group. In another example, the networking service can transmit a list of the identified users to the users themselves. In yet another example, the networking service can display the list on the user's profile or account page automatically.

From any of these lists, a user can select an entry to view a prospective contact's profile information. If the user decides to connect with the prospective contact, the user can send the contact a message, by way of example. In this manner, the user can arrange face-to-face networking lunches with prospective contacts with some knowledge of the contacts' abilities or desires to meet the user's networking needs.

The present disclosure can be applied to numerous career development environments. For example, using the career development networking service, colleges and universities can accelerate the career advancement and professional networking of their alumni. By matching alumni professionals with comparable career skills and experiences, the career development networking service can leverage the resources of alumni in a structured, focused way, thus developing a peer network for supporting job searches and career progression.

In another example, prospective employees can gather deeper information about career positions and roles by being matched with an individual currently filling the role. A prospective employee can read the public profiles of employees in the desired role, read their career narratives on their current job role, and participate in chats around career narratives for their current job role. The depth of information sharing possible during the recruiting process by matching a professional aspiring to a new job position with a professional currently holding that position greatly increases the likelihood of finding a candidate for the job role who has at least one characteristic required or preferred by an employer, including, for example, a skill set, a personality characteristic or trait, and an indication of a length of time for which the candidate is likely to remain in the role.

In further examples, the networking service can create opportunities to improve college and graduate degree recruiting process. Matching professionals who aspire to a new college or graduate degree with alumni who currently hold the degrees can improve the flow of information and investigation during the recruiting process. Further, by viewing the public profiles of enrolled students, recruiters at college and graduate schools can review a prospective employees' career path and career aspirations. Additionally, prospective employees can gather deeper information about a position and role by being matched with an individual currently filling the role. In other examples, individuals aspiring to a degree can read public profiles of alumni in desired career roles and paths to gather more information on how a degree will contribute to professional success.

Using the network service, conference and event providers can recruit additional registrants. For example, a working professional can receive matches for prospective career-related networking contacts upon registering for an event and begin to engage with matched connections in pre-event networking. In other example, a professional can receive an invitation to register for an event based on profiles of other professionals attending the event who would make good career-related networking contacts.

The networking service can enhance skills training and career advising opportunities by matching professional peers who hold similar job positions. Professionals pursuing opportunities for improved skills training and career advising can be members of a company, non-profit organization, or government agency. These professionals can be individual consumers investing personal financial resources in career development. The networking service can match these professionals with consulting professionals who have expertise in the desired skill area and can contribute to others' professional development. In this manner, peer-to-peer matching of professionals around training needs can produce a more efficient exchange of career-enhancing information than traditional training that runs through third-party vendors.

Having described certain embodiments of methods and systems for matching users with career-related events and prospective career-related networking contacts, it will now become apparent to one of skill in the art that other embodiments incorporating the concepts of the disclosure may be used. Therefore, the invention should not be limited to certain embodiments, but rather should be limited only by the spirit and scope of the following claims:

1. A method for identifying a career-related event for a user of a career development networking service, the method comprising:
receiving, by a server, profile information of a user;
matching, by the server, the user with a group of users of a career development networking service based on the profile information of the user and profile information of the group of users;
identifying, by the server, a career-related event attended by a threshold number of users matched to the user; and
displaying, by the server, the career-related event to the user.

2. The method of claim 1, further comprising enhancing, by the server, the profile information of the user.

3. The method of claim 2, wherein enhancing the profile information of the user further comprises identifying skills, educational credentials, or transition opportunities for acquisition based on the profile information of the user.

4. The method of claim 2, wherein enhancing the profile information of the user further comprises analyzing profile information of users of the professional networking service with whom the user forms connections.

5. The method of claim 4, wherein enhancing the profile information of the user further comprises analyzing skills, roles, or educational credentials of the users of the professional networking service with whom the user forms connections.

6. The method of claim 2, wherein enhancing the profile information of the user further comprises retrieving information about activities of the user from a third-party server.

7. The method of claim 2, wherein matching the user with a group of users further comprises
matching the user with a group of users based on the enhanced profile information of the user and profile information of the group of users.

8. The method of claim 1, wherein receiving the profile information of a user further comprises receiving prioritized objectives of the user.

9. The method of claim 8, wherein matching the user with a group of users further comprises weighting users with profile information that matches the prioritized objectives of the user.

10. The method of claim 1, wherein displaying the career-related event further comprises
sending, by the server, an invitation to the career-related event to the user.

11. A method for identifying prospective career-related networking contacts attending a career-related event for a user of a career development networking service, the method comprising:
receiving, by the server, a selection of a career-related event from a user;
receiving, by the server, a request for an enumeration of attendees of the career-related event according to a criterion;
identifying, by the server, attendees of the career-related event that meet the criterion; and
displaying, by the server, the identified attendees to the user.

12. The method of claim 11, wherein receiving a request for an enumeration of attendees further comprises receiving a request for an enumeration of attendees of the career-related event that meet networking criteria based on the profile information of the user.

13. The method of claim 11, wherein receiving a request for an enumeration of attendees further comprises receiving a request for an enumeration of attendees of the career-related event that meet a criterion selected by the user.

14. The method of claim 13, wherein receiving a request for an enumeration of attendees further comprises receiving a request for an enumeration of attendees of the career-related event that meet a career family, career path, role, goal, or company selected by the user.

15. The method of claim 11, wherein displaying the identified attendees further comprises highlighting the identified attendees.

16. The method of claim 11, further comprising displaying attendees that do not meet the criterion after the attendees that meet the criterion.

17. An apparatus for identifying a career-related event and prospective networking targets for a user of a career development networking service, the apparatus comprising:
a receiver for receiving profile information of a user of a career development networking service;
a profile generation and enhancement engine for generating and enhancing profile information of the user;
a matching and recommendation engine for
i) matching the user with a group of users of the career development networking service based on the profile information of the user and profile information of the group of users,
ii) identifying a career-related event attended by a threshold number of users from the group of users,
iii) receiving a request for an enumeration of attendees of the career-related event according to a criterion; and
iv) identifying attendees of the career-related event that meet the criterion; and
a user interface generation engine for generating a user interface to display
i) the career-related event, or
ii) the identified attendees.
